(19) United States
(12) Patent Application Publication
(10) Pub. No.: US 2026/0244569 A1
(43) Pub. Date: Aug. 20, 2026

(54) WORKLOAD MAPPING TO MATRIX MULTIPLICATION ENGINES

(71) Applicant: OpenAl Opco, LLC, San Franicsco, CA (US)

(72) Inventors: Ramyad Hadidi, University Park, MD (US); Amin Firoozshahian, Mountain View, CA (US)

(73) Assignee: OpenAl Opco, LLC, San Francisco, CA (US)

(21) Appl. No.: 19/540,513

(22) Filed: Feb. 13, 2026

Related U.S. Application Data
(60) Provisional application No. 63/758,793, filed on Feb. 14, 2025.

(51) Int. Cl. G06F 12/06

(52) U.S. Cl. CPC G06F 12/0607

(57) ABSTRACT

The present disclosure provides systems and techniques for sustaining tensor workloads on tiled architectures. A processing system with processors operates compute tiles coupled by an interconnect to a memory subsystem. Per tile compute engines perform tensor computations, accumulate partial results, and retain accumulations to completion. A system address decoder configures an addressing scheme that provides tile private address ranges for data used by a tile and tile shared address ranges for data used by multiple tiles. In a first parallelization mode, the system distributes parameter data among compute tiles while making input data available across tiles. In a second parallelization mode, the compute tiles generate partial results for a common output space and propagate the partials among neighbor tiles to an owner tile that completes accumulation and commits the output. The system schedules fused execution that overlaps data movement and computation to maintain a steady state.

### CROSS-REFERENCE TO RELATED APPLICATIONS

This application claims the benefit, pursuant to 35 U.S.C. § 119(e) and 37 C.F.R. § 1.78(a), of U.S. Provisional Application No. 63/758,793, filed February 14, 2025. The disclosure of U.S. Provisional Application No. 63/758,793 is hereby incorporated by reference herein in its entirety.

### BACKGROUND

Modern high-performance computing platforms increasingly employ tiled or domain-partitioned architectures to accelerate data-intensive workloads such as machine-learning training, inference, and large-scale numerical simulations. In these systems, many compute tiles, each with local memory resources and one or more matrix-multiplication (tensor) engines, share access to a memory subsystem that can include high-bandwidth memory (HBM), memory-side caches, and pseudo-channels. While this design enables substantial parallelism, it also raises challenges in coordinating where data resides and how data is moved so that per-tile engines can progress without stalling or over-consuming limited local memory.

To sustain performance, distributed systems often rely on on-chip interconnects (e.g., rings or multi-ring fabrics), channelization of memory traffic, and address-mapping schemes that steer requests to appropriate channels and tiles. As system scale and workload intensity increase, the cost of moving activations, weights, and partial results can dominate compute time. Static or coarse memory mappings, insufficient locality, or uncoordinated reduction of partial sums may create hot spots, increase re-access of inputs, or force premature write-backs that degrade bandwidth utilization.

Many modern AI workloads are dominated by general matrix–matrix multiplication (GEMM) operations, including feed-forward network (FFN) up-projection, gate-projection, and down-projection phases. Practical deployments distribute work in multiple ways: for example, by sharding model parameters across tiles while broadcasting inputs, or by producing partial results for a common output space that must be accumulated or reduced. Without careful scheduling, these approaches can incur redundant movement of inputs or weights and can transiently inflate intermediate activation tensors beyond per-tile budgets. Further, quantized parameter storage (e.g., groups of consecutive elements sharing a scale value) and engine-preferred layouts introduce additional constraints on addressing granularity, channel alignment, and dataflow needed to keep per-tile engines fed at line-rate.

### SUMMARY

The present disclosure provides systems, methods, and techniques that coordinate memory address decoding and channel interleaving with tile‑level parallelization modes. This coordination sustains steady‑state pipeline transfers and computations, localizes communication onto neighbor links while enabling owner‑based accumulation for shared output regions, and bounds intermediate tensor growth and re‑access of input data, all while operating within tight per‑tile memory budgets and across diverse matrix dimensions.

Modern large‑scale machine‑learning and numerical workloads rely heavily on matrix and tensor operations whose performance is often limited by data movement rather than raw compute. The present disclosure addresses this constraint in systems that partition work across many compute tiles by orchestrating where data resides, how it is shared, and when partial results are combined. This orchestration avoids redundant reads, mitigates hot spots on memory channels, and prevents multi‑hop reductions from overwhelming bandwidth and inflating latency.

For tiled accelerators, the present disclosure sustains performance by coupling per‑tile compute engines with a memory subsystem that distinguishes tile‑private data from tile‑shared data. Private placement keeps most accesses local to a tile’s associated channels, while shared placement enables predictable exchange of activations and results among tiles. An interconnect (e.g., rings or multi‑ring fabrics) provides short, neighbor‑to‑neighbor paths so that collaboration remains localized rather than devolving into system‑wide traffic.

The present disclosure provides complementary parallelization modes that benefit workloads such as feed‑forward network (FFN) layers. In a first mode, model parameters are sharded across tiles and inputs are made available to all tiles so each engine independently produces a disjoint slice of the output. In a second mode, tiles generate partial sums in a common output address space and cooperatively propagate and accumulate those partials to an owner tile that finalizes the result. Used in concert, the two modes limit parameter re‑movement, confine communication to short links, and ensure only completed outputs are committed.

The present disclosure also provides memory addressing techniques that steer traffic and structure data placement. A system address decoder assigns bit‑fields that map addresses to channels and tiles, producing recognizable tile intervals and channel intervals. With this structure, the system spreads load across channels and reserves private regions for weights or working buffers while exposing separate shared regions for inputs and outputs. This discipline turns ad hoc transfers into repeatable, schedulable streams.

In some embodiments, a computing system includes a processing system comprising one or more processors, a plurality of compute tiles, a memory subsystem, and an interconnect arranged to communicate the compute tiles. The processors are configured to operate the compute tiles to perform tensor computations using per‑tile compute engines that accumulate partial results, set a memory addressing scheme using a system address decoder that provides tile‑private address ranges for data used by a given tile and tile‑shared address ranges for data used by multiple tiles, execute a first parallelization mode in which a parameterized portion of a model dataset is distributed among at least a portion of the compute tiles and input data is made available across the compute tiles, execute a second parallelization mode in which the compute tiles produce partial results for a common output address space and propagate the partial results among neighbor tiles to an owner tile that completes accumulation and commits the output, and perform a fused execution to maintain a steady state.

In some aspects, a method includes operating compute tiles to perform tensor computations using per‑tile compute engines that internally accumulate partial results to completion; managing a memory addressing scheme using a system address decoder that provides tile‑private address ranges for data used by a given tile and tile‑shared address ranges for data used by multiple tiles; executing a first parallelization mode in which a parameterized portion of a model dataset is distributed among tiles and input data is made available across tiles, the mode advancing work across tiles; executing a second parallelization mode in which tiles produce partial results for a common output address space and propagate the partial results among neighbor tiles to an owner tile that completes accumulation and commits the output; and performing a fused execution across projection and gating operations to maintain a steady state and avoid growth of intermediate activation tensors while overlapping data movement and computation within a per‑tile memory budget.

In yet other aspects, an apparatus comprises a processing system including one or more processors, a plurality of compute tiles, a memory subsystem, and an interconnect arranged to communicate among the compute tiles. The processors are configured to operate the compute tiles to perform tensor computations using per‑tile compute engines that internally accumulate partial results to completion; manage a memory addressing scheme using a system address decoder that provides tile‑private address ranges and tile‑shared address ranges; execute a first parallelization mode in which a parameterized portion of a model dataset is distributed among tiles and input data is made available across tiles, the mode advancing work across tiles; execute a second parallelization mode in which tiles produce partial results for a common output address space and propagate the partial results among neighbor tiles to an owner tile that completes accumulation and commits the output; and perform a fused execution across projection and gating operations to maintain a steady state and avoid growth of intermediate activation tensors while overlapping data movement and computation within a per‑tile memory budget.

By unifying tile‑aware addressing, complementary parallelization modes, and fused steady‑state execution, the present disclosure localizes traffic, minimizes redundant movement of inputs, parameters, and partial sums, and enables owner‑based commits for shared outputs. This approach improves bandwidth utilization, lowers latency, and supports scalable deployment of matrix‑multiplication engines across tiled accelerators for machine‑learning and other tensor‑centric workloads.

### BRIEF DESCRIPTION OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings, and the claims.

FIG. 1 illustrates an example operational flow for a tiled computing system that configures addressing, executes complementary parallelization modes, and performs fused execution to maintain a steady state, in accordance with some aspects of the present technology.

FIG. 2 illustrates an example block diagram of a tiled computing architecture including processors, compute tiles, a memory subsystem, and an interconnect, in accordance with some aspects of the present technology.

FIG. 3A illustrates an example memory map in which a system address decoder provides tile‑private (coarse‑grain interleaved) and tile‑shared (fine‑grain interleaved) address ranges, in accordance with some aspects of the present technology.

FIG. 3B illustrates an example bit-field assignment that maps tile and channel identifiers in system addresses to establish tile and channel interleaving intervals, in accordance with some aspects of the present technology.

FIG. 3C illustrates an example reversed bit-field assignment for input/output traffic shaping that adjusts how tile and channel identifiers are mapped to tune interleaving intervals, in accordance with some aspects of the present technology.

FIG. 4 illustrates an example schematic of tile‑level channelization and engine block dimensions usable for staging and processing matrix blocks within tiles, in accordance with some aspects of the present technology.

FIG. 5 illustrates an example schedule of a first parallelization mode in which parameter shards are distributed across tiles and input blocks advance among tiles in steps, rounds, and sweeps, in accordance with some aspects of the present technology.

FIG. 6 illustrates an example schedule of a second parallelization mode in which tiles generate partial results, propagate them via neighbor hops, and reduce to an owner tile that commits the output, in accordance with some aspects of the present technology.

FIG. 7 illustrates an example per‑tile block diagram including a core, local memory, a direct memory access (DMA) engine, a tensor (GEMM) engine with an internal accumulator, and a tile interconnect interface, in accordance with some aspects of the present technology.

FIG. 8 illustrates an example fused execution sequence spanning up‑projection, gate‑projection, an in‑place gating operation, and down‑projection with output write‑back, in accordance with some aspects of the present technology.

### DETAILED DESCRIPTION

The following disclosure provides various embodiments and examples for implementing features of the invention. Specific examples of components and arrangements are described to simplify the present disclosure. These examples are not intended to be limiting. For instance, the formation of a first feature over or on a second feature may include embodiments in which the two features are in direct contact, as well as embodiments in which additional features are interposed between them. Reference numerals and/or letters may be repeated across examples for clarity and simplicity, and such repetition does not imply a specific relationship between embodiments.

Some of the disclosed embodiments are described with reference to the accompanying drawings. However, it will be understood by those skilled in the art that the principles of the example methods and systems may be practiced without every specific detail. Well-known methods, procedures, and components have not been described in detail so as not to obscure the principles of some of the disclosed methods and systems. Unless explicitly stated, the example methods and processes described herein are neither constrained to a particular order or sequence nor constrained to a particular system configuration. Additionally, some of the described methods and systems or elements thereof can occur or be performed (e.g., executed) simultaneously, at the same point in time, or concurrently. Reference will now be made in detail to some of the disclosed methods and systems, examples of which are illustrated in the accompanying drawings.

It is to be understood that both the foregoing general description and the following detailed description are only explanatory and are not restrictive of this disclosure. The accompanying drawings, which are incorporated in and constitute a part of this specification, illustrate several disclosed methods and systems and together with the descriptions serve to outline principles of some of the disclosed methods and systems.

Spatially relative terms such as “beneath,” “below,” “lower,” “above,” “upper,” and similar descriptors are used for convenience in describing the relative positioning of elements as illustrated in the figures. These terms are intended to encompass different orientations of the device in use or operation, and should not be interpreted as limiting the scope of the invention to the depicted orientation.

In tiled computing platforms that accelerate matrix and tensor operations, sustained performance often depends more on how shared activations and intermediate results are moved among compute tiles and memory channels than on peak arithmetic throughput. Redundant reads of identical activation blocks and premature write-back and re-read of partial sums can inflate bandwidth demand, deepen queues at memory interfaces, and create burst-sensitive tail latency for training and inference phases. These effects may under-utilize per-tile engines and data-movement resources even when nominal compute capacity is ample.

System-level behavior therefore may determine how precise data placement and movement are orchestrated: for example, which data is local to a tile, which data is shared, how requests are steered across memory channels, where partial results are accumulated, and which paths on the interconnect are exercised. Without coordination, many-to-one reads and fan-in reductions can crowd shared links, stress memory-side caches, and cause variable service times that dominate step duration for common operators such as general matrix–matrix multiplication in feed-forward network layers.

These pressures may become more acute as models and batch sizes grow and as operators span more tiles. If each tile independently issues the same activation read, the memory subsystem may serve the same data repeatedly; if each tile writes a partial and a later stage re-reads and combines those partials, the system may pay twice for intermediates. Software-only coordination and ad hoc tile-to-tile forwarding can reduce but not eliminate these effects, and may still stall under shared-range hot spots or non-deterministic cache behavior.

Quantized parameter storage and engine-preferred layouts introduce alignment and granularity constraints that, if not reflected in the address mapping and per-tile scheduling, can leave channels under-utilized or cause unnecessary re-access of inputs and weights. When the addressing scheme and parallelization choices are decoupled, intermediate activations may transiently grow beyond a per-tile budget and disrupt steady-state overlap of movement and compute.

To address these limitations, the disclosed technology may coordinate a system address decoder that may establish tile-private address ranges using coarse-grain interleaving and tile-shared address ranges using fine-grain interleaving; complementary parallelization modes that either shard parameters with shared inputs or generate partials in a common output address space with neighbor-to-neighbor accumulation to an owner tile; and fused execution that overlaps projections and a gating operation so that intermediate tensors need not be materialized beyond a per-tile memory budget while engines remain supplied at line rate. In example embodiments, these choices localize most private traffic to a tile’s associated channels, confine cooperative communication to short neighbor hops, and keep commits deterministic at an owner tile.

In one aspect, a computing system may include a processing system with one or more processors, compute tiles, a memory subsystem, and an interconnect arranged to communicate the compute tiles. The processors may operate the tiles to perform tensor computations using per-tile compute engines that accumulate partial results; set a memory addressing scheme via a system address decoder that provides tile-private ranges for data used by a given tile and tile-shared ranges for data used by multiple tiles; execute a first parallelization mode in which a parameterized portion of a model dataset is distributed among at least a portion of the tiles while input data is made available across the tiles; execute a second parallelization mode in which tiles produce partial results for a common output address space and propagate the partials among neighbor tiles to an owner tile that completes accumulation and commits the output; and perform a fused execution to maintain a steady state.

In some embodiments, the fused execution may span projecting and gating operations, such as an up-projection and a gate-projection followed by an in-place gating operation, and may be configured to avoid growth of intermediate activation tensors while overlapping data movement and computation within a per-tile memory budget. In these embodiments, the memory addressing scheme may explicitly define tile-private address ranges, for example for weight shards and partial-sum scratch space, and tile-shared address ranges, for example for inputs and outputs, to sustain steady-state operation and predictable bandwidth use.

In certain implementations, the memory addressing scheme may be configurable at system boot to adjust both the granularity of tile-level access, referred to as a tile interval, and the granularity of channel-level access, referred to as a channel interval. This may allow the same hardware to be retuned as model size, batch size, or domain partitioning changes, while preserving the higher-level software model and ensuring that placement and steering remain deterministic.

In some embodiments, the memory addressing scheme may be implemented by a system address decoder of the memory subsystem that assigns channel identifiers and tile identifiers to predetermined bit positions. By interpreting these fields, the system may realize channel intervals and tile intervals that steer requests to per-tile channel groups for private data and stripe shared-range traffic broadly when appropriate, aligning addressing behavior with engine and DMA feed characteristics.

In example configurations, the channel identifiers occupy bits 17–16 and the tile identifiers may occupy bits 28–25, which may yield a channel interval on the order of about 64 KB and a tile interval on the order of about 64 MB. These settings may align transfer granularity with compute block dimensions and minimum burst sizes, while preserving per-tile locality for private placement and simplifying verification of ownership and routing.

For input or output data, the bit positions of the channel identifiers and the tile identifiers may be reversed to shape traffic. This may increase the significance of the channel identifier disseminates shared reads across many channels while rotating small chunks across tiles, reducing hot spots when many tiles fetch adjacent input blocks concurrently and improving bisection bandwidth utilization on shared phases.

In some embodiments, parameter weights of the model dataset are stored within a tile-private address range in a quantized format in which groups of consecutive elements may share a scale value. This placement may support column-major streaming into per-tile engines while keeping reads on the owning tile’s channels and ensuring that dequantization metadata is fetched in lockstep with the corresponding elements.

In some examples, each group may include at least 32 elements that may share a single scale so that reads can consume runs of elements followed immediately by the corresponding scale. This may help conserve bandwidth, simplify hardware buffering, and allow engine pipelines to maintain steady consumption without irregular stalls.

The parameter weights can be stored contiguously, for instance as padded column-major columns aligned to channel intervals, so engines stream regularly aligned segments while data-movement hardware rotates across channels within a tile to sustain multichannel feeding and minimize idle cycles on any given channel.

In the first parallelization mode, progress may be organized into steps, rounds, and sweeps. Each step may pair an input sub-block and a local weight sub-block; a round advances the input window across tiles by neighbor passes; and a sweep progresses through a stripe of the parameter shard to complete the tile’s output slice. This structure maintains overlap between staging, compute, and handoff.

In some embodiments, during the first mode a tile performs a matrix multiplication on a staged input-data block using its per-tile compute engine may occur, and then may pass that input block via the interconnect to a neighbor tile. The neighbor’s next-in-line block becomes the new head of the window on the following step, limiting re-reads from memory and keeping the pipeline in steady state.

A windowing mechanism may select non-contiguous input-data blocks using a stride that is a function of the inner matrix dimension, the tile count, and the engine block width. This may help keep transfers aligned to channel intervals and maintains the working set within per-tile memory while supplying the engines at line rate across successive steps.

In some examples, the stride is k may be divided by the product of the tile count and the per-tile block width, maintaining a compact, repeatable access stream that balances overlap of movement and compute. Such a stride may help distribute fetches evenly across channels while ensuring that each input element participates in accumulation without unnecessary duplication.

The first mode’s scheduling may reduce redundant movement of parameter data and output data for an output region of the common output address space and bounds re-access of input data. Each weight column can be read once per tile while inputs are circulated predictably among neighbors rather than repeatedly fetched from memory, which may stabilize latency and reduce memory-side queue depth.

In some embodiments, fused execution may perform an up-projection and a gate-projection in the first parallelization mode, applies a gating operation in place, and may perform a down-projection in the second parallelization mode in which tiles propagate running partial sums neighbor-to-neighbor to an owner tile that completes accumulation and commits the output. This may help avoid materialization of large intermediate tensors and aligns commit locality with the address-to-tile mapping so that final writes are deterministic.

In another aspect, a method may include operating compute tiles to perform tensor computations using per-tile compute engines that internally accumulate partial results to completion; managing a memory addressing scheme via a system address decoder that provides tile-private and tile-shared ranges; executing a first parallelization mode that distributes a parameterized portion of a model dataset among tiles while making input data available across tiles so that work advances; executing a second parallelization mode that produces partial results for a common output address space and propagates the partials among neighbor tiles to an owner tile that completes accumulation and commits; and performing a fused execution across projection and gating operations to maintain a steady state and avoid growth of intermediate tensors beyond a per-tile budget.

In embodiments of the method, the memory addressing scheme may explicitly define tile-private address ranges and tile-shared address ranges so that placement and traffic shaping remain predictable across iterations and domains. Declaring private ranges may allow weight shards, working buffers, and accumulator scratch to remain localized to a tile’s associated channels, which reduces cross-tile interference and simplifies bandwidth accounting. Declaring shared ranges for inputs and outputs may let many tiles access common data without hot spots by distributing requests at a finer granularity, and also provides a defined space into which owner-tile commits can be written once when reductions complete. This division of address space may align naturally with the first and second parallelization modes and supports repeatable steady-state behavior.

The method can include configuring, at system boot, the granularity of tile-level access (tile interval) and the granularity of channel-level access (channel interval) so that the same physical decoder supports different interval settings across models or deployments. Adjusting these intervals at boot may enable a platform to retune for larger or smaller inner dimensions, for different batch sizes, or for changes in domain partitioning, without altering the higher-level programming model. Coarser tile intervals can emphasize locality when private footprints grow, whereas finer channel intervals can widen striping for heavily shared reads to maintain utilization during many-to-many access phases. Coordinated configuration across tiles and channels may yield deterministic placement and repeatable pipelines as workloads evolve.

The method can further include assigning channel identifiers and tile identifiers to predetermined bit positions in the system address decoder to realize channel intervals and tile intervals that align with engine and data-movement characteristics. Fixing the field positions may provide a deterministic mapping from addresses to tile ownership and channel selection, allowing software to compute ownership and placement in advance and enabling hardware to steer traffic without additional lookups. This determinism may support straightforward derivation of the owner tile for reductions, simplifies cache-line alignment and minimum transfer sizing, and balances ring load by rotating accesses predictably across channels. Stable field assignments also may improve observability and bring-up because traceability from an address to its serving tile and channel is explicit and consistent.

In a further aspect, an apparatus may comprise a processing system including one or more processors, a plurality of compute tiles, a memory subsystem, and an interconnect arranged to communicate among the compute tiles. The processors may be configured to operate per-tile compute engines that retain accumulation to completion; manage a system address decoder that provides tile-private and tile-shared ranges; execute first and second parallelization modes as discussed above; and perform fused execution that overlaps movement and compute to maintain a steady state within a per-tile memory budget. Hardware building blocks of an example apparatus are depicted and described in connection with the figures herein.

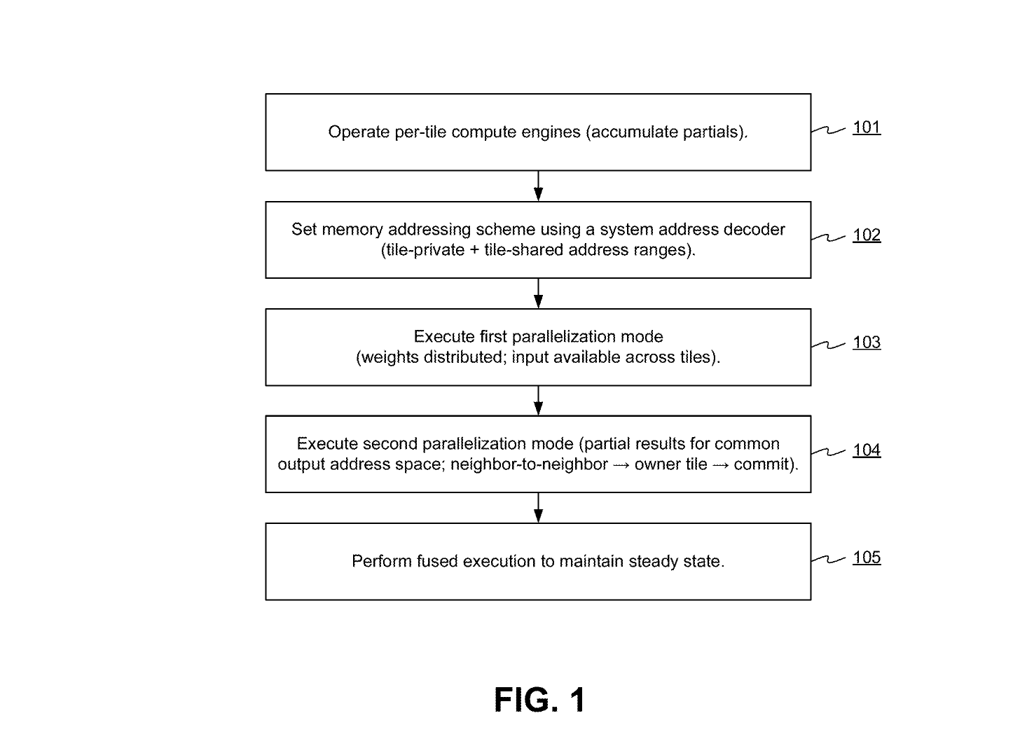

FIG. 1 illustrates a flowchart of operations for a tiled computing system, in accordance with some aspects of the present technology. The flowchart depicts a high‑level control sequence that processors may execute to coordinate compute tiles, memory placement, and inter‑tile communication so that matrix/tensor workloads proceed efficiently. The depicted ordering may be one example, and steps may be performed in different orders, repeated, overlapped, or omitted in various implementations.

The flowchart of FIG. 1 begins at step 101, which may state “operate per‑tile compute engines (accumulate partials).” A compute tile may refer to a processing node that may include a tensor or matrix‑multiplication engine (e.g., a GEMM engine), local memory, and data‑movement resources (e.g., a DMA engine or tile interconnect interface). A per‑tile compute engine may be logic configured to perform kernel operations on blocks of activation and parameter data, such as matrix multiply‑accumulate on sub‑matrices. A partial (or partial result) may be an intermediate accumulation for a subset of an output region prior to final reduction and commit. Operating the per‑tile compute engines may include staging input and parameter blocks into local memory, issuing instructions to perform multiply‑accumulate operations, and retaining the engine’s accumulator contents until completion of the relevant output block. Retaining accumulators locally may reduce premature write‑backs and may allow computation to overlap with transfers of subsequent blocks.

At step 102, the processing system may set a memory addressing scheme using a system address decoder. The system address decoder may interpret selected address bits as tile and/or channel identifiers to form tile‑private address ranges (which may be used primarily by a given tile) and tile‑shared address ranges (which may be accessible or shared among multiple tiles). Tile‑private ranges may be realized with coarser‑grain interleaving to maximize locality, while tile‑shared ranges may use finer‑grain interleaving to distribute shared traffic. The addressing scheme may be configurable (e.g., at boot) to adjust interleaving granularities and may, in some embodiments, be arranged differently for input/output data to shape traffic patterns. Establishing these ranges may enable predictable placement of parameters, activations, and outputs so that the subsequent parallelization modes operate with bounded contention.

At step 103, the flowchart indicates execution of a first parallelization mode in which a parameterized portion of a model dataset (which may include model parameter data, model parameter, and/or parameter tensors) may be distributed among tiles and input data may be made available across tiles. In some embodiments, parameter sharding may assign disjoint subsets of model weights to respective tiles (or tile groups), while input availability may be maintained by broadcasting, passing, or otherwise sharing input blocks so that each tile can compute its output slice with local parameters. The first mode may proceed according to a schedule that may include steps, rounds, and sweeps. A step may include reading a weight block and an input block, performing a multiply‑accumulate to update the tile’s local partials, and moving the input block to a neighbor tile. A round may include repeating steps while shifting an input window so that tiles collectively process a set of input blocks. A sweep may include advancing to a next portion of the parameter shard (e.g., a new column group) and restarting rounds until the output slice is completed. The first mode may reduce redundant movement of parameters, may bound re‑access of input blocks, and may keep tile engines supplied at line rate.

At step 104, the flowchart indicates execution of a second parallelization mode in which tiles may produce partial results for a common output address space and may propagate those partials among neighbor tiles to an owner tile that may complete accumulation and commit the output. The common output address space may refer to a logical arrangement of output locations that multiple tiles contribute to, according to the addressing scheme set in step 102. A neighbor may refer to a tile that is one hop away on the interconnect (e.g., a ring or multi‑ring), and a neighbor hop may refer to a single‑link transfer of a partial result from one tile to its neighbor. An owner tile may be the tile responsible for final accumulation and write‑back for a given output region, which may be determined by an address‑to‑tile mapping derived from the addressing scheme. In operation, each tile may compute its local partial for the shared region, add any received partial from a neighbor, and forward the running sum to the next neighbor, until the owner tile receives the final partial, completes the accumulation, and commits (e.g., writes) the result to the memory subsystem.

At step 105, the flowchart indicates performing fused execution to maintain a steady state. Fused execution may refer to scheduling two or more related kernel operations so that intermediate activations may be produced and consumed in close succession, thereby reducing the need to materialize large temporaries in memory. For example, projections and gating operations (e.g., up‑projection, gate‑projection, an in‑place gating operation, and down‑projection) may be fused such that the output of one stage may immediately feed the next. A steady state may refer to a pipeline condition in which data transfers (e.g., tile‑to‑tile passes and memory moves) may overlap with compute so that successive iterations proceed without stalls and without unbounded growth of intermediate tensors. Achieving steady state may include provisioning sufficient buffering (e.g., ping‑pong or ring buffers), retaining accumulators in the per‑tile engines until completion, and aligning the first and second parallelization modes so that input sharing and neighbor reductions progress continuously.

The steps depicted in FIG. 1 may be applied to a variety of workloads and hardware organizations. As used herein, terms such as tile, per‑tile compute engine, partial, tile‑private, tile‑shared, neighbor, owner tile, common output address space, and fused execution may be interpreted broadly to include functionally equivalent components and operations that may vary by device count, interconnect topology, memory technology, quantization format, or scheduling policy. In different embodiments, the processors may repeat, interleave, or reorder the steps to adapt to model size, batch size, or runtime conditions.

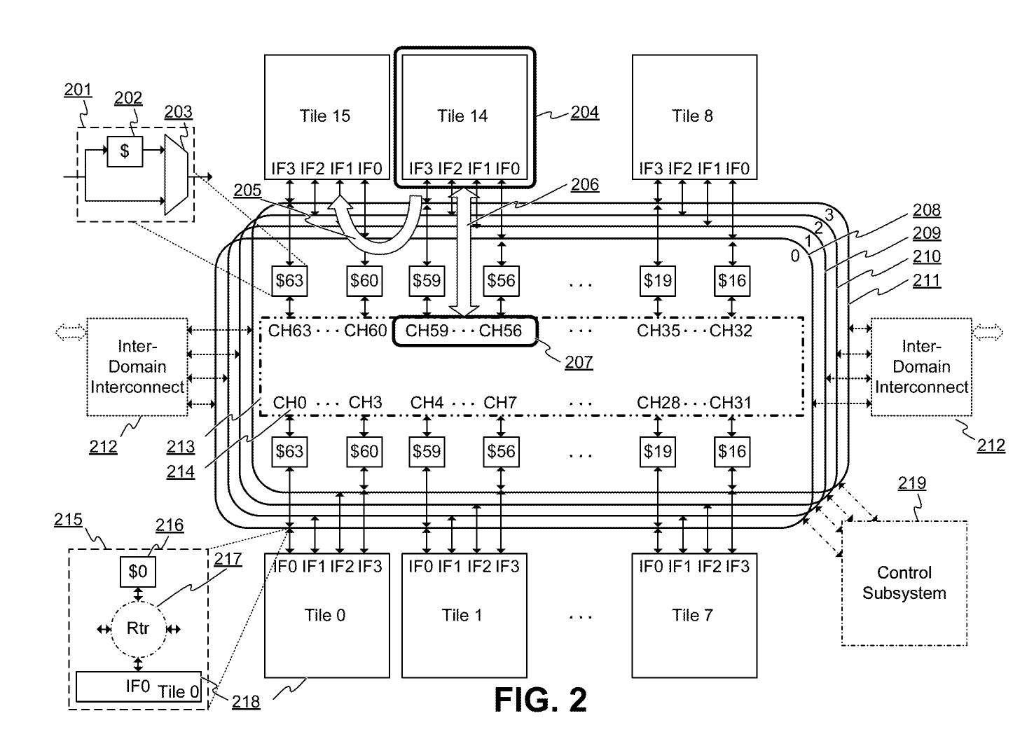

FIG. 2 illustrates a system‑level block diagram of a tiled computing architecture in which processors, compute tiles, a memory subsystem with multiple channels (or pseudo‑channels), and a multi‑ring on‑chip interconnect may cooperate to execute parallel tensor workloads with controlled data placement and predictable traffic. The drawing may group logical functions with dotted outlines, identify example tiles and channel groupings, and show how short neighbor transfers and address‑decoder policies may localize private traffic while shaping shared flows.

Dotted box 201 may denote a configuration and control primitive that may be used to establish system parameters for the interconnect and memory subsystem. As used herein, a configuration primitive may include logic that may accept control descriptors, firmware writes, or memory‑mapped register accesses and may emit control signals to downstream blocks. Register 202 may be one such memory‑mapped or CSR register that may store values for address‑decoder policies, tile‑to‑channel associations, interleaving granularities, ring utilization modes, or rate‑limit thresholds. Selector/decoder 203 may interpret the content of register 202 and may generate control outputs, such as choosing between default and reversed TileID/ChID bit‑field assignments, enabling fine‑grain versus coarse‑grain interleaving for particular ranges, or activating per‑class traffic shaping on selected rings. In various embodiments, the combination of 201–203 may allow boot‑time provisioning as well as runtime retuning when workload or model characteristics change.

Highlighted tile 204 (Tile 14) may represent a compute tile selected for exposition of locality and sharing concepts in this system. A compute tile, as used herein, may include a core or micro‑controller, a per‑tile tensor or matrix‑multiplication engine, local memory or buffers, a DMA engine, and one or more tile interfaces (e.g., IF3/IF2/IF1/IF0) that may inject and eject traffic to the interconnect. Curved arrow 205 may exemplify a neighbor hop, which may be a one‑hop transfer on a ring from a given tile to the next tile. Neighbor hops may be used in a first parallelization mode to pass input‑data windows from tile to tile without repeatedly re‑reading the same activations from memory, and in a second parallelization mode to circulate running partial sums so that each tile may add its contribution before forwarding. As used herein, a ring may include a unidirectional or bidirectional loop of links and routers that may carry packets or flits between tiles and channel endpoints; a neighbor may be the next router or tile on that loop. Neighbor hops may reduce latency and may minimize head‑of‑line (HoL) blocking, which, as used herein, may include a condition in which a blocked packet at the front of a queue prevents later packets behind it from advancing even if their destinations are currently free. By keeping exchanges to short, single‑hop paths and by distributing flows across multiple rings, the system may reduce the likelihood and impact of HoL blocking.

Down arrow 206 may indicate an association of highlighted tile 204 with a subset of memory channels, and bracket 207 may identify the example channel group for that tile. As used herein, a channel or pseudo‑channel may include a memory‑side endpoint (such as a port of a high‑bandwidth memory controller) that may accept read and write requests and may return or commit data. Associating each tile with a bounded set of channels may allow tile‑private address ranges (e.g., weight shards, working buffers, or partial‑sum scratch) to be mapped by construction onto that tile’s channels, which thereby may confine most private traffic and simplifying bandwidth accounting. Channels may be grouped per tile for several reasons: a fixed grouping may isolate per‑tile traffic and ease QoS enforcement; a symmetric grouping (e.g., four channels per tile) may simplify address‑map arithmetic; and an adjustable grouping may let the control subsystem trade locality against peak bandwidth as model size, batch size, or domain partitioning changes. In some embodiments, the grouping indicated by bracket 207 may be enforced by a system address decoder that may interpret TileID and ChID bit fields to realize tile intervals (coarse‑grain interleaving for private ranges) and channel intervals (the stride among the tile’s channels). For shared inputs and outputs, the decoder may optionally use a reversed field placement to spread or shape traffic while preserving the private placement policy.

Elements 208–211 may represent four concentric rings (e.g., ring 0 as the innermost through ring 3 as the outermost) that the system may use in parallel. Multiple rings may increase bisection bandwidth, may separate traffic classes (for instance, dedicating one ring to private reads and another to shared reductions), or may provide additional virtual lanes for fairness. As used herein, bisection bandwidth may represent the aggregate bandwidth available across the narrowest cut that divides the interconnect into two halves. Increasing bisection bandwidth may reduce worst-case contention during many-to-many exchanges (e.g., shared reads and reductions). As used herein, a virtual channel may include a logically independent queue and credit pool that may share a physical link; provisioning multiple virtual channels per ring may reduce HoL blocking by allowing one traffic class to progress even if another class is momentarily stalled. The control subsystem may stripe a long stream over 208–211 to balance load, or it may reserve a specific ring for latency‑sensitive owner‑tile commits.

Inter‑domain interconnects 212 on the left and right may denote links between tile domains, where a domain, as used herein, may include a subset of tiles and channels managed as a logical unit for very large models or multi‑tenant deployments. Inter‑domain links may carry cross‑domain inputs when the first parallelization mode spans domains, or they may carry owner‑tile commits when the address‑to‑tile mapping for a shared output region falls in a different domain. In some embodiments, the inter‑domain connection may be implemented as bridge routers on the ring edges; in others, the connection may traverse a separate fabric tier for die‑to‑die or board‑to‑board aggregation. As used herein, a bridge router may be a router instance that terminates one fabric or ring domain and re-emits traffic into another domain (or fabric tier) while preserving ordering and QoS metadata needed by the flow. As used herein, a fabric tier may be a higher-level interconnect layer above the local rings—for example, a package-to-package or board-level link—that carries traffic between domains or aggregates results across systems. As used herein, die‑to‑die aggregation may represent a package‑level interconnect arrangement that combines or bridges traffic between two or more separately fabricated dies within the same package, so that flows (e.g., shared inputs or owner‑tile commits) can be collected on one die, forwarded across a die‑to‑die link, and re‑emitted into the destination die’s fabric without exiting the package. For example, reductions that span domains on different dies may traverse a dedicated bridge at the die edge. As used herein, board‑to‑board aggregation may reference an interconnect arrangement that transports and combines traffic across printed‑circuit boards—e.g., via a backplane, mid‑plane, or cabled fabric tier—so that results or shared data produced on one board are forwarded and merged with traffic from other boards at a higher level of the system. For example, an owner‑tile commit destined for a tile in a different chassis domain may be forwarded over a board‑to‑board link.

Dotted box 213 near the center may represent a logical fabric core that may include memory‑side components such as cache slices or channel controllers, arbitration logic for channel endpoints, and address‑decode logic that may apply the policies selected by configuration elements 201–203. The dotted outline may indicate that these resources are logically central but may be physically distributed around the ring to meet timing and layout constraints. Reference label 214 may anchor channel numbering and orientation in the diagram; more generally, the “CHxx” labels may denote the set of channels or pseudo‑channels available to the memory subsystem. In practice, each channel may comprise request queues, schedulers, refresh and timing management, and optional memory‑side caching for shared data or burst absorption. As used herein, burst absorption may represent a memory‑side cache or buffer near the channel endpoints which may temporarily absorb short‑duration surges of many small or coincident requests by coalescing them into cache‑line‑granular transactions and/or pacing them toward DRAM, thereby smoothing instantaneous bandwidth demand and reducing queue buildup at the channel schedulers. For example, when many tiles read the same input block, the memory‑side cache may serve hits locally rather than issuing repeated DRAM reads.

Dotted block 215 at the lower left may provide a zoomed view of a local tile/router cluster to clarify injection and ejection. Within that block, register 216 may be a local configuration or status register analogous in role to register 202 but scoped to a tile or nearby router. For example, register 216 may hold a tile‑specific mask for private and shared ranges, a per‑tile rate limit for shared traffic, or counters that may be sampled by the control subsystem for adaptive tuning. The inner dotted circle labeled “Rtr” may denote a router 217 that may connect tile interfaces to the rings and may implement per‑ring virtual channels, credit‑based flow control, and programmable arbitration. As used herein, injection may include enqueueing a packet from a tile interface into a ring’s virtual channel when sufficient credits are available, and ejection may include removing a packet at the destination tile or channel endpoint. Router 217 may also implement fixed‑function neighbor forwarding for the second parallelization mode so that partial sums can advance reliably one hop per step with minimal control overhead. As used herein, fixed‑function neighbor forwarding may reference a hardware‑assisted router behavior that, once enabled for a flow, may automatically forward a received block on the next neighbor link with minimal per‑packet decision logic and no software intervention, optionally updating a tag or hop‑count, to guarantee one‑hop‑per‑step progress for pipelines such as the partial‑sum reduction in the second parallelization mode. For example, each tile may add its local contribution and the router forwards the running partial to the next tile in the ring in the same step. Tile 0 218 in the zoomed box may correspond to tile 0 218 in the global view; in various embodiments, the same “tile 0” label may appear both in the local inset and along the bottom row to anchor discussion of address mapping, injection points, and associated channels for that tile.

Control subsystem 219 may represent one or more processors, firmware, and driver components that may orchestrate system operation. The control subsystem may program registers 202 and 216, select policies via selector/decoder 203, establish address‑to‑tile mapping for owner tiles in the second parallelization mode, and schedule the first and second modes so that compute, tile‑to‑tile transfers, and memory traffic remain in steady state. As used herein, an owner tile may include the tile responsible for completing accumulation and committing a given output region to memory. The identity of the owner tile may be derived from the addressing policy applied by the system address decoder. The control subsystem may further collect performance counters from channels and rings, detect back‑pressure or error conditions, and adapt window sizes, stride parameters, ring assignments, and rate limits at runtime to maintain utilization while avoiding congestion. As used herein, back-pressure may reference flow-control signaling from downstream queues (e.g., ring VCs or channel schedulers) that throttles further injection until occupancy drops below a threshold, preventing buffer overflow and head-of-line blocking.

The additional labels in the drawing may provide context for the foregoing behaviors. The “$xx” tags adjacent to channels may denote memory‑side cache slices or control/status points that may buffer shared inputs or reflect channel‑local state. The “IF0–IF3” tags beneath each tile may denote individual tile interfaces that may be dedicated to traffic classes or collectively used to stripe a flow across multiple rings. The grouped channel labels (e.g., CH63–CH60 at the top, CH35–CH32 at mid‑right, and CH0–CH3 along the bottom) may illustrate that channel endpoints may be physically distributed to multiple locations on the ring to spread injection points and reduce localized hot spots. In operation, the association indicated by down arrow 206 and bracket 207 may confine highlighted tile 204’s private traffic to its channel group, curved arrow 205 may advance data or partials by neighbor hops without global traversal, and the multi‑ring structure 208–211 together with inter‑domain interconnects 212 may provide the lanes required to overlap private reads, shared passes, and owner‑tile commits. Collectively, these structures may enable the address‑aware placement and dual‑mode parallel execution described elsewhere to proceed with bounded contention and predictable performance.

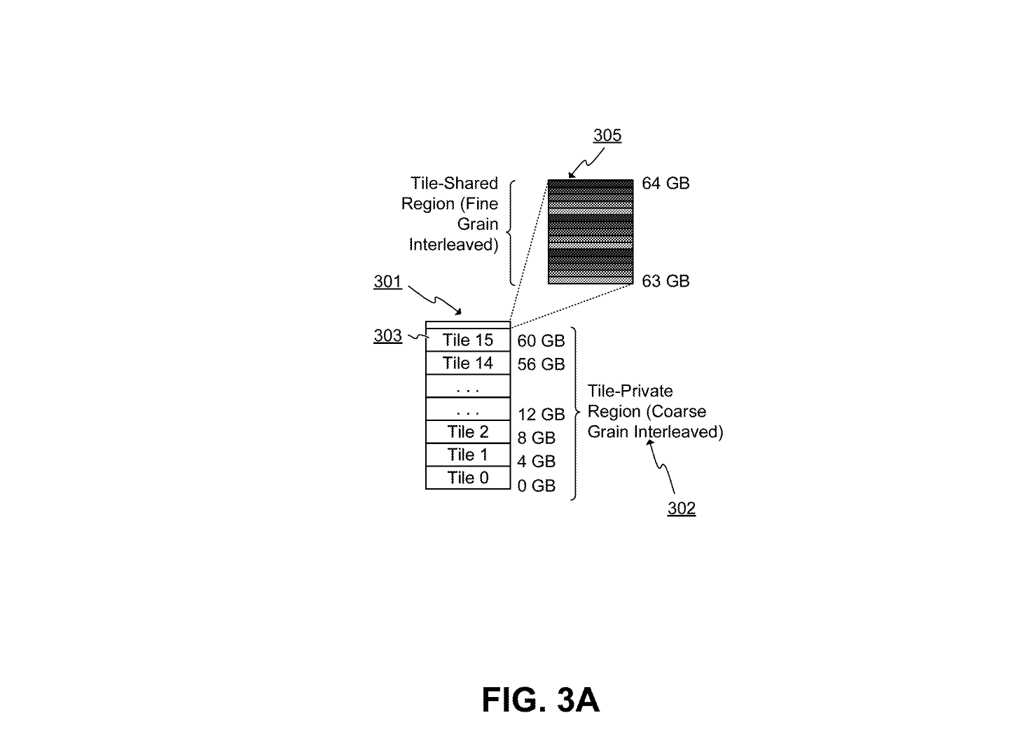

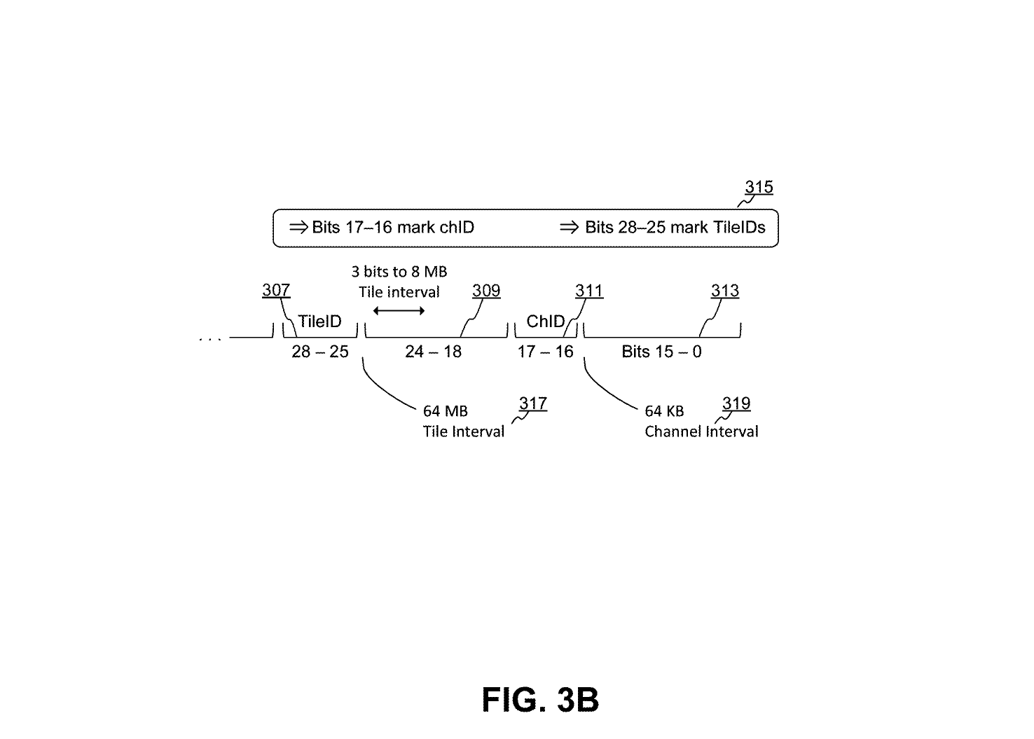

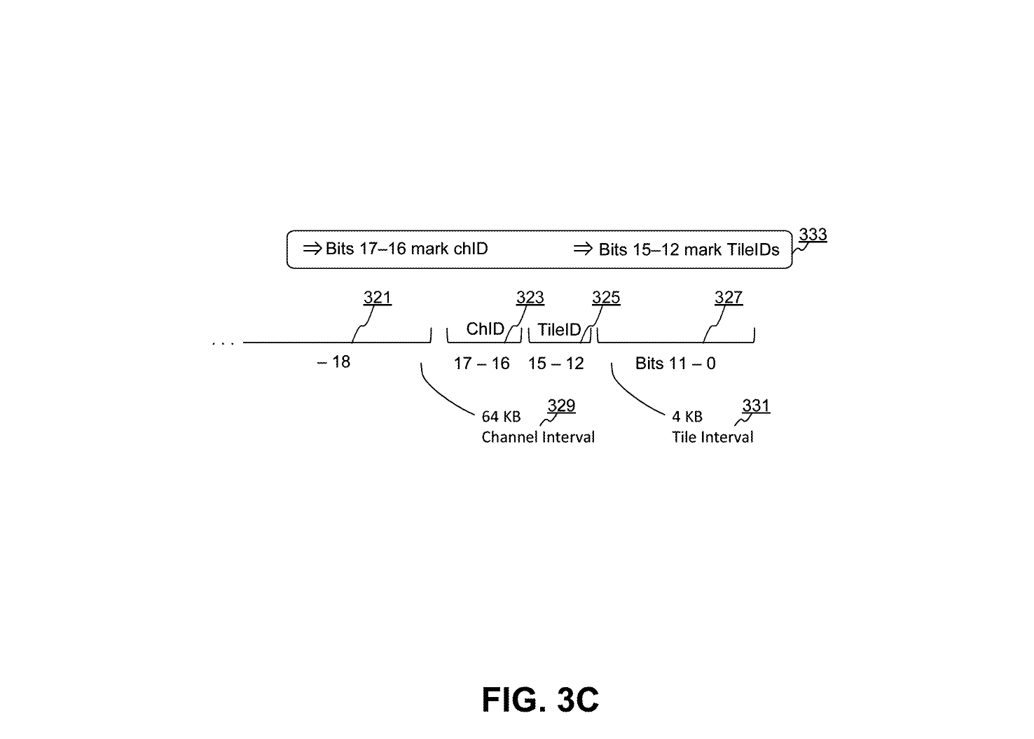

FIG. 3A illustrates a memory map managed by a system address decoder. System address map 301 depicts a contiguous system address space partitioned into a tile‑private region 302 and a tile‑shared region 305. A system address decoder may interpret selected address bits as tile and/or channel identifiers to realize interleaving policies across tiles and channels. As used herein, interleaving includes assigning consecutive addresses (or address strides) across multiple destinations (e.g., channels or tiles) to distribute traffic and balance load. For example, coarse‑grain interleaving may change destinations at relatively large strides to promote locality, while fine‑grain interleaving may change destinations at smaller strides to spread shared flows.

Within tile‑private region 302, representative tile‑private interval 303 points to a single tile’s private interval (illustrated with “Tile 15” as an example row). A tile‑private interval may include the portion of the address space predominantly used by one tile (e.g., for that tile’s weight shards, working buffers, or partial‑sum scratch). Mapping each tile’s private data into its own interval may keep the majority of that tile’s memory traffic localized to its associated channels, which may help avoid cross‑tile interference and may simplify bandwidth planning. The vertical stacking of entries (e.g., “Tile 0 … Tile 15”) within tile-private region 302 shows how successive coarse‑grain address intervals may be assigned to respective tiles from a base address (e.g., 0 GB) upward; interval sizes and ordering may be programmable (e.g., at boot) to match model footprints, domain partitioning, or physical placement of channels around the interconnect.

The zoomed band represents the tile‑shared region 305, which may be fine‑grain interleaved across channels and is shown near the top of the system address map 301. The dark‑striped band and dashed zoom‑lines indicate that the tile‑shared region fits within the upper part of the same global address space depicted by system address map 301, but employs a finer interleaving policy than the tile‑private rows beneath it. A tile‑shared region may include address ranges accessed by multiple tiles for commonly consumed data (e.g., input activations during the first parallelization mode) and/or produced cooperatively (e.g., down‑projection outputs reduced to an owner tile during the second parallelization mode). Fine‑grain interleaving in tile-shared region 305 may allow shared reads/writes to be striped across many channels to sustain bandwidth and reduce localized hot spots, while the tile‑private placement in tile-private region 302 may preserve locality for per‑tile data.

FIG. 3B illustrates a default bit‑field assignment that the system address decoder may apply when mapping addresses to tiles and channels. Top policy box 315 may summarize that certain higher‑order address bits may mark TileID and certain mid‑order bits may mark ChID. Bracket 307 may identify the TileID field (e.g., address bits 28–25 in one embodiment), which may select which tile’s private interval is being addressed and may underpin an address‑to‑tile mapping used to determine the owner tile for a given output region. As used herein, address‑to‑tile mapping may refer to a rule derived from the system address decoder’s bit‑field assignment that associates an address with a responsible tile—such as by interpreting a TileID field—to select the owner tile for placement or commit. For example, addresses sharing the same TileID may resolve to the same tile‑private interval for writes. Bracket 311 may identify the ChID field (e.g., address bits 17–16 in one embodiment), which may select which channel in the owning tile’s channel group is used for a given access. Bracket 313 may identify the Offset field (e.g., bits 15–0) within the selected tile/channel interval. As used herein, Offset field may refer to the intra‑interval address bits that select a byte position within the tile‑private or tile‑shared interval identified by TileID and ChID. For example, different Offset values within the same TileID and ChID may select different cache line addresses served by the same channel.

Intermediate bracket 309 may indicate sub‑tiling bits (e.g., bits 24–18 in one embodiment) that may be available to refine layout within a tile’s private interval. As used herein, sub‑tiling may include selecting sub‑regions inside a tile‑private interval to meet additional layout goals (e.g., bank alignment, page coloring, or internal domain partitioning) without changing which tile or channel group serves the request. Label 317 may denote the tile interval, which may be the address distance between consecutive TileID values under the default mapping. For example, in one embodiment, the tile interval may be on the order of about 64 MB, meaning all addresses sharing a TileID may map into the same tile‑private range. Label 319 may denote the channel interval, which may be the address distance between consecutive ChID values. For example, in one embodiment, this address distance may be on the order of about 64 KB, allowing offsets within a tile’s private range to round‑robin across that tile’s channels. As used herein, round‑robin may refer to a cyclical selection pattern in which successive accesses advance uniformly through a finite set of destinations—such as a tile’s channels—before returning to the first destination. For example, offsets that advance at the channel interval may cause transfers to visit ch0, ch1, ch2, and ch3 in turn, then repeat the sequence. As used herein, tile interval and channel interval may be parameterized by the chosen bit positions and the memory subsystem’s minimum transfer granularity. In some embodiments, changing those parameters may adjust the effective intervals accordingly.

Operationally, this default assignment may be used to place tile‑private data (e.g., contiguous, column‑major weight storage tailored for an engine’s feed pattern) and to route an owner tile’s completed output commits deterministically into the owner’s private interval. In the first parallelization mode, accessing a weight column may walk offsets inside a single TileID while ChID may naturally parallelize transfers across the tile’s channels. As used herein, walk offsets inside may refer to incrementing the Offset field within a fixed TileID value so that accesses remain within the same tile‑private interval while traversing address sub‑ranges that can be distributed across channels by the ChID bits. For example, advancing the Offset field by the channel interval may rotate otherwise contiguous reads across the owning tile’s channels without changing the TileID. In some embodiments, in the second mode, an owner tile may commit a completed block to its private range, which may keep write‑backs localized and predictable. As used herein, second mode may refer to a parallelization mode in which tiles produce partial results for a common output address space and propagate running partial sums among neighbor tiles until an owner tile completes accumulation and commits the output. For example, a down‑projection block may be reduced hop‑by‑hop to the owner tile and then written once to the owner’s private interval. Keeping commits localized and predictable may reduce cross‑tile interference on shared links, simplify bandwidth and QoS planning, and improve latency determinism by confining final writes to the owner’s channel group rather than dispersing them across the fabric. For example, deterministic owner‑tile commits may avoid cache thrash and queue buildup that would otherwise occur when many tiles issue non‑localized write‑backs to shared ranges.

FIG. 3C illustrates a reversed bit‑field assignment that the system address decoder may apply to shape shared input/output traffic. Top policy box 333 may summarize that certain mid‑order address bits may mark ChID and certain lower‑order bits may mark TileID for the relevant ranges. Bracket 321 may identify an upper portion of the address (e.g., bits 18 and above in one embodiment) that may remain common for the shared range, bracket 323 may identify the ChID field (e.g., bits 17–16), bracket 325 may identify the TileID field at a smaller granularity (e.g., bits 15–12), and bracket 327 may identify the Offset field (e.g., bits 11–0). As used herein, reversed mapping may refer to a bit‑field assignment for selected ranges in which the relative significance of ChID and TileID is swapped with respect to the default mapping so that channel selection advances at a larger stride while tile selection advances at a smaller stride. For example, under a reversed mapping, consecutive line‑aligned offsets may rotate transfers broadly across channels while small chunks round‑robin across tiles.

Under this reversed policy, label 329 may denote a channel interval that may remain on the order of about 64 KB so that shared transfers are broadly striped across channels, while label 331 may denote a tile interval reduced to a smaller order (e.g., about 4 KB) so that successive, small data chunks round‑robin across tiles. As used herein, I/O shaping may include arranging address fields so that shared reads and writes may be naturally disseminated across channels and tiles at a granularity that matches the producer/consumer rhythm of the pipeline. For example, placing shared inputs under a reversed mapping may let many tiles fetch adjacent input blocks in parallel without colliding on the same channel, while placing owner‑committed outputs back into the default‑mapped tile‑private ranges may keep final writes localized to the owner’s channel group. As used herein, striped across channels may refer to distributing consecutive transfers so that they target different channels in a repeating pattern to keep all channels busy. For example, consecutive line‑aligned accesses may visit ch0, ch1, ch2, and ch3 and then repeat.

This reversal may matter because the access patterns for shared inputs and intermediate results are fundamentally different from the access pattern for final owner commits. For shared reads, emphasizing ChID at higher significance may distribute bursts across many channels and reduce contention when multiple tiles issue similar requests at the same time. For example, tiles that consume neighboring input blocks may hit different channels by construction, which may maintain high channel utilization and avoid head‑of‑line blocking. For commits, retaining the default mapping may keep writes deterministic and local to the owner tile’s channel group, which may stabilize latency and simplify bandwidth and QoS planning. As used herein, localized commit may refer to writing a completed output block into the owner tile’s private interval so that the write stays on the owner’s associated channels. For example, the commit path may avoid cross‑tile traversal and reduce interference with shared read traffic.

In practical terms, reversing the fields for shared ranges may increase parallelism where many consumers read the same or adjacent data, while preserving locality for owner‑finalized writes. This separation of policies may help maintain a steady‑state pipeline in which data movement overlaps with computation without creating hot spots on shared links or forcing partial results to be written and re‑read unnecessarily. For example, shared input streams may be serviced in a striped pattern over channels, and completed results may be committed once into predictable tile‑private intervals.

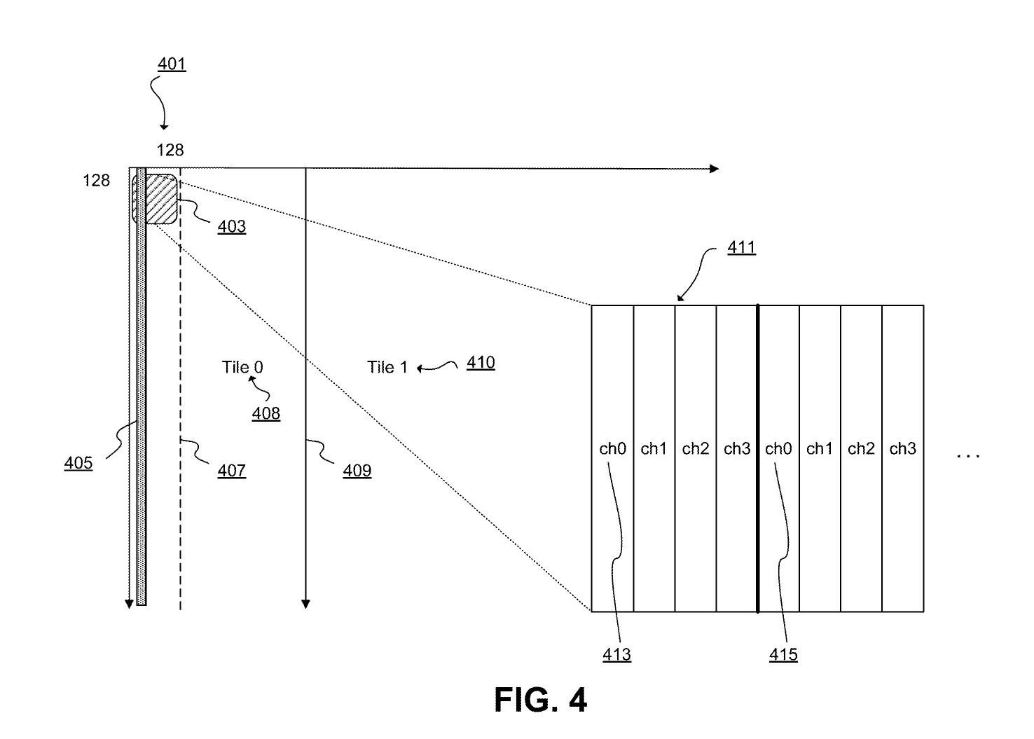

FIG. 4 illustrates per-tile channelization and an engine block dimension that may be used to stage and process matrix blocks inside a tiled computing system. Two neighboring tiles may be shown for context, Tile 0 408 and Tile 1 410. An inter-tile divider arrow 409 may mark the divider between Tile 0 408 and Tile 1 410 and may also indicate the orientation of tile indices along the horizontal axis. The inter-tile divider arrow 409 may be drawn so that it appears continuous to emphasize that the tile sequence may extend beyond the two tiles shown. A dotted boundary 407 may denote the left boundary of the Tile 0 408 tile-private interval as depicted. The dotted boundary 407 may function as a schematic alignment indicator rather than a data path, and it may help a reader see where tile-private placement for Tile 0408 begins relative to the shaded exemplar regions described below.

Engine block dimension 401 may mark an engine block dimension of 128 by 128 elements. This dimension may describe the size of the matrix subproblem that a per-tile engine processes in one accumulation pass. As used herein, elements may be numeric entries of an activation matrix or a weight matrix, such as floating-point or quantized integers. A 128 by 128 engine block may mean the engine reads a block of 128 rows of activations and a block of 128 columns of weights to produce a 128 by 128 output submatrix for a portion of the common output address space. Choosing 128 by 128 may balance local memory usage, channel transfer granularity, and compute utilization. It may align with the channel interval used for column-major weight storage so that columns can be streamed in chunks that are natural for the engine while keeping all channels active. In other embodiments the engine block may be 64 by 128, 128 by 256, 256 by 256, or another rectangular size. A different size may be selected to match a different engine width, a different cache line size, a different channel interval, or a different quantization layout. A weight block for this engine may be a contiguous unit of weight data sized and aligned to supply a 128-element column segment to the engine and may include the scale metadata that accompanies quantized elements. Organizing weight blocks in column-major order may let the engine consume columns in fixed-size segments while rotating reads across channels so that compute may overlap with data movement. The engine may retain accumulation state for the output submatrix until accumulation completes for that block so that partial sums need not be written back and later re-read. Retaining accumulation in this way may support operator fusion and steady-state scheduling, since the engine may begin consuming the next input segments while the previous block partial sums remain local until completion. This may reduce redundant traffic and may help bound intermediate tensor size.

A potential first tile-private weight placement 403 may represent a range in the system address space that is predominantly served by channels associated with a single tile. The potential first tile-private weight placement 403 may hold a shard of model parameters that the tile processes locally. The system may place weight columns inside this range so that reads may stay on the owning tile channels, which may reduce cross-tile interference and may simplify bandwidth planning. Detail view 411 may expand the internal arrangement of a potential first tile-private weight placement 403 so a reader can see how the placement may feed channels within a tile in a regular pattern. The detail view 411 may be split into two halves, where the first half may correspond to the first tile context and the second half may correspond to the neighbor tile context. Each half may show its own local channel numbering that starts from channel zero. Channel zero may be identified in the first half at 413 and in the second half at 415. Using channel zero at both positions may prevent a reader from assuming that the right half is a continuation of the left half, because each half may represent a per-tile view with its own channel index base.

Within detail view 411, weight columns may be aligned and distributed across per-tile channels to sustain multi-channel feeding. A weight column may be the set of weight elements for a particular output feature arranged so that increasing addresses traverse one logical column. Weight elements may be quantized so that groups of consecutive elements share a single scale value and the scale may be stored contiguously with each group. Aligning each column to a channel interval may allow reads to rotate across channels ch0 through ch3 inside the tile while keeping transfers within the tile-private placement. The positions of channel zero at the first half 413 and the second half 415 may show the base for per-tile channel numbering and may orient how the rotation progresses within each tile.

A potential second tile-private weight placement 405 may be structurally the same kind of placement as a potential first tile-private weight placement 403, and it may demonstrate that the same per-tile organization may repeat for adjacent tiles.

The arrangement inside potential first and second tile-private weight placements 403 and 405 may be sized by grouping columns into column stripes. A column stripe may be a bundle of one hundred twenty-eight columns aligned at the channel interval so that each column may fill a channel-aligned slot. A stripe may be on the order of eight megabytes for the example operator when each column is padded to the channel interval. A full operator may require one hundred twenty-eight stripes across the output width. A domain of sixteen tiles may receive eight stripes per tile so that each tile may hold a per-tile stripe of about sixty-four megabytes. A per-tile stripe may be the aggregation of stripes assigned to a tile and placed within the tile-private addressing range. The system may choose a tile interval that is larger than the per-tile stripe so that all columns assigned to a tile may fit within the tile private placement. A tile interval may be the address distance at which placement may move from one tile to another in the system address space. Choosing intervals in this way may confine most weight traffic to the channels of the owning tile and may reduce contention on shared links.

The dotted boundary 407 may be used as a tile-private interval boundary indicator in this figure. The mark may show where the Tile 0408 placement begins relative to a potential first tile-private weight placement 403 and where the inter-tile divider arrow 409 sits on the other side of that region. The dotted boundary 407 may be a visual aid and may not imply a hardware barrier. The dotted boundary 407 may be omitted or replaced by another alignment indicator in other drawings. The inter-tile divider arrow 409 may be drawn to highlight both the separator between tiles and the direction of increasing tile index. The inter-tile divider arrow 409 may serve as a cue that the per-tile pattern shown by tile-private weight placements 403 and 405 may repeat across tiles. Labels for Tile 0 408 and Tile 1 410 may then make clear which side is which for the two-tile snapshot used in this schematic.

With this organization the 128 by 128 engine block dimension 401 may harmonize with the channelized layout inside detail view 411. Columns may feed the engine in units that match the engine width. Local staging may hold input activations and weight blocks sized to the same granularity so that compute and data movement may overlap. The engine may keep partial sums until a block is complete and may then commit final results to memory in an owner-based pattern described elsewhere. The per-tile placement may keep reads local, and channel rotation may keep the channels busy. The inter-tile divider arrow 409 and the dotted boundary 407 may orient a reader without implying a special interconnect at that location.

Numerical values in this figure may vary with engine width, model shape, and the number of channels per tile. The number of columns in a stripe may change, the channel interval may change, and the tile interval may change. The dotted boundary 407 may be replaced by another boundary indicator, the inter-tile divider arrow 409 may be drawn differently or omitted, and the two halves of detail view 411 may be extended to show more tiles. The use of channel zero at the first half 413 and the second half 415 may generalize to other channels when more channels are present. In some embodiments, the system may be adjusted altering these values while preserving the per-tile locality and per-channel feeding principles that the figure teaches.

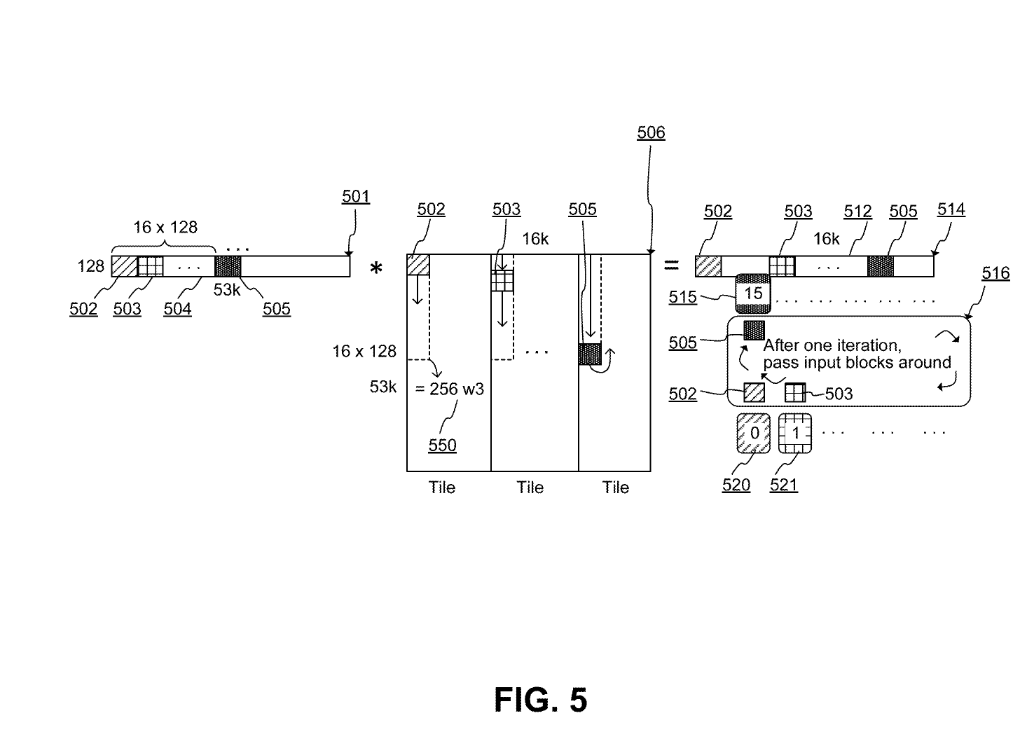

FIG. 5 illustrates an access stream for a first parallelization mode in which weights remain distributed across tiles while an input activation window advances from tile to neighbor tile after each step. The figure may progress from a source bar 501, through a multiply panel 506 that is organized by tiles, to a destination bar 514 to the right of an equal sign. The labels may show how a step pairs one input sub‑block with one weight sub‑block, how the input may then be passed to the next tile, and how partial results may accumulate into designated output regions as the window advances.

The source bar 501 may represent the input activation window presented to the domain for the current iteration. The vertical 128 to the left of source bar 501 may indicate that each step stages 128 activation elements in the row dimension for the engine. The long horizontal 53k under tail 505 may indicate an inner matrix dimension k on the order of fifty‑three thousand elements, for example k = 53,248, across which input sub‑blocks may be selected. A windowing mechanism may select non-contiguous input sub-blocks at a stride set as a function of the inner dimension and engine geometry so that tiles progress across k without redundant re-reads. As used herein, in some embodiments, a stride may be set to k/(T×B), where k is the inner dimension, T is the tile count, and B is the per-tile engine block width, which shapes selection so transfers align to channel intervals and keep the engine at line-rate while bounding local-memory use. For example, with k = 53,248, T = 16, and B = 128, the stride may evaluate to 26, matching the channel-aligned block cadence used to maintain steady-state overlap of transfer and compute. The annotation 16 by 128 over the front portion of source bar 501 may denote that the window may be organized as a sequence of sixteen sub‑blocks, each sized to 128 activation rows. Three exemplars within this repeating sequence are labeled and then tracked consistently across the figure. The first exemplar head 502 may be the head of the window. Next-in-line 503 may be the next‑in‑line sub‑block that becomes the head on the following step when the current head is passed to the neighbor. Tail 505 may be the tail that is furthest from consumption and will become active after intervening sub‑blocks have been processed. At the beginning of an iteration, the head 502 may be newly staged, the next‑in‑line 503 may be staged or in flight from a prior pass, and the tail 505 may be pending at the far end of the current window. As used herein, in flight may refer to data that is currently traversing the interconnect or is buffered for immediate handoff between tiles, but has not yet been fully staged in the destination tile’s local memory. Sub‑block count and size may be chosen to keep the engine supplied at line‑rate while bounding local memory use. As used herein, bounding local memory use may refer to selecting window sizes, sub‑block dimensions, and buffering patterns so that the working set resident on a tile—such as the active input sub‑block, the current weight sub‑block, and any in‑progress partial sums—remains within that tile’s provisioned local memory budget. For example, a tile may use ping‑pong or ring buffering to overlap transfers and compute without exceeding its local memory allocation. As used herein, working set may refer to the set of data blocks concurrently resident in local memory that are required to service the current step while maintaining overlap with subsequent steps. In other embodiments, the window may include a different number of sub‑blocks and each sub‑block may be sized to 64 by 128, 128 by 256, 256 by 256, or another rectangular size to match a different engine width, cache‑line size, channel interval, or quantization layout. If k is not an integer multiple of the chosen sub‑block width, the tail 505 may include padding so that the final step remains aligned.

The multiply panel 506 may depict the per‑step compute activity across tiles for the same iteration using the same three identities head 502, next-in-line 503, and tail 505. The left tile column may show head 502 arriving at a tile, being multiplied with that tile’s local weight sub‑block, and progressing through the compute pipeline during this step. The center tile column may show next‑in‑line 503 acting as the head at the neighbor during the same step. The right tile column may show tail 505 later in the sequence as it approaches the end of its local traversal and is about to be passed onward at step completion. The downward arrows drawn over head 502, next-in-line 503, and tail 505 may represent the stepwise flow through staging, compute, and handoff rather than a physical movement in memory. The annotation 16 by 128 to the right of multiply panel 506 may indicate that the scheduling and staging granularity match the front‑of‑window organization on source bar 501 so that a round may process sixteen sub‑blocks of 128 rows each. As used herein, step may refer to one scheduling quantum in which a tile processes a paired input and weight sub‑block and then advances the window by passing the input to the neighbor tile. As used herein, round may refer to a sequence of steps sufficient for each tile to process one position of the window, after which the window position has advanced by one across the domain. As used herein, window may refer to the ordered set of input sub‑blocks currently staged or circulating among tiles for processing.

The notation 53k at the left of multiply panel 506 may emphasize the extent of the k dimension traversed by the window. The notation 16k across the top of multiply panel 506 may indicate an example layer width n on the order of sixteen thousand columns, for example n = 16,384, into which output updates are written as the sequence advances. The label 550 placed at the bottom of the left tile column may explain the small arrow that points to “= 256 w3.” This annotation may indicate that the effective compute for the depicted step aggregates 256 weight elements along three internal weight lanes or groups, which may be expressed as w3. As used herein, w3 may denote a three‑way grouping parameter on the weight path, for example three channels, three sub‑columns, or three internal lanes in the engine’s feed, and the value 256 may denote the number of weight elements or bytes aggregated per step at that point. Other embodiments may use different grouping parameters and counts, for example 128w2 or 512 w4, depending on the chosen engine width, vector lanes, channel arrangement, or quantization format. Although multiply panel 506 may be drawn with three tile columns for clarity, the same pattern may extend to any tile count, and the window length may be set accordingly to maintain a steady state.

To the right of the equal sign the destination bar 514 may be partitioned using the same identities of head 502, next-in-line 503, and tail 505, with an ellipsis 512 indicating the intervening positions updated by other tiles during the same round. The head 502 may identify the portion of the output that the tile working on head 502 updates in the current step. The next region labeled next-in-line 503 may identify the portion updated by the neighbor that is working on next‑in‑line 503 during the same step. The ellipsis 512 may summarize intermediate output regions written by additional tiles as the window advances during the step. The region labeled tail 505 near the right may identify the portion ultimately updated when the tail 505 reaches the head position at its turn. The small tag 515 placed below the bar may remind the reader that, in a sixteen‑tile domain, a sub‑block experiences fifteen neighbor passes to complete one full circulation. The bracketed callout 516 may summarize this pass‑around behavior by indicating that after one iteration the system may pass input blocks around so the window advances by one position per step. As used herein, neighbor pass may refer to a one‑hop transfer on the interconnect that moves the head sub‑block from the current tile to the next tile in the ring so that the next tile becomes responsible for that sub‑block on the following step.

The callout box to the right of bracketed callout 516 may depict only the three identities used throughout the figure so that the circulation order is easy to follow. The ordering may be tail 505 then head 502 then next-in-line 503, which may emphasize that the former tail becomes a head in a later step, the current head is passed to the neighbor, and the current next‑in‑line becomes the next head. Two auxiliary markers may appear below as small bubbles labeled 0 and 1, identified as marker 520 and marker 521, respectively. Marker 520 may correspond to a head‑style sub‑block analogous to head 502, and marker 521 may correspond to a next‑in‑line‑style sub‑block analogous to next-in-line 503. These markers may serve only to anchor the first two positions in the cycle and may not imply additional hardware structures.

A step may proceed in three phases that align with these labels. First, a tile may stage the head 502 from the window together with the next weight sub‑block from its local vertical stripe. As used herein, vertical stripe may refer to a bundle of weight columns grouped and aligned to the channel interval within a tile’s private range so that reads can rotate across channels while feeding the engine at a fixed column‑major cadence. Second, the per‑tile engine may compute a matrix multiply between the staged input and weight sub‑blocks and accumulate into the tile’s assigned portion of the output, which updates the region on the destination bar that corresponds to that tile in the current step. Third, the tile may advance by staging its next weight sub‑block and by passing the just‑consumed head 502 to the neighbor, which promotes the neighbor’s next‑in‑line 503 to the new head for the next step. The tail 505 may shift forward by one position in the window and a new tail may be staged as needed. This staging–compute–advance rhythm may allow transfers to overlap with compute and may maintain a steady state through the iteration. As used herein, steady state may refer to a pipeline condition in which staging, compute, and neighbor passes proceed in an overlapped, repeating rhythm across successive steps and rounds without buffer underflow or overflow, thereby avoiding stalls while respecting the per‑tile memory budget.

The specific numbers shown in FIG. 5 are illustrative and not limiting. The activation height of 128 elements on source bar 501 may vary. The inner dimension annotated as 53k may vary with model width. The layer width annotated as 16k may vary with configuration. The sub‑block organization labeled 16 by 128 in source bar 501 and multiply panel 506 may be replaced by other rectangular sizes such as, but not limited to, 64 by 128, 128 by 256, or 256 by 256. The grouping indicated by 550 may use values other than 256 and grouping factors other than w3. The number of tiles in the domain and the number of sub‑blocks in the window may change accordingly. The arrangement may accommodate these variations while preserving the principles of keeping weights in tile‑private placement, advancing input sub‑blocks by neighbor passes, and updating designated output regions as the schedule proceeds.

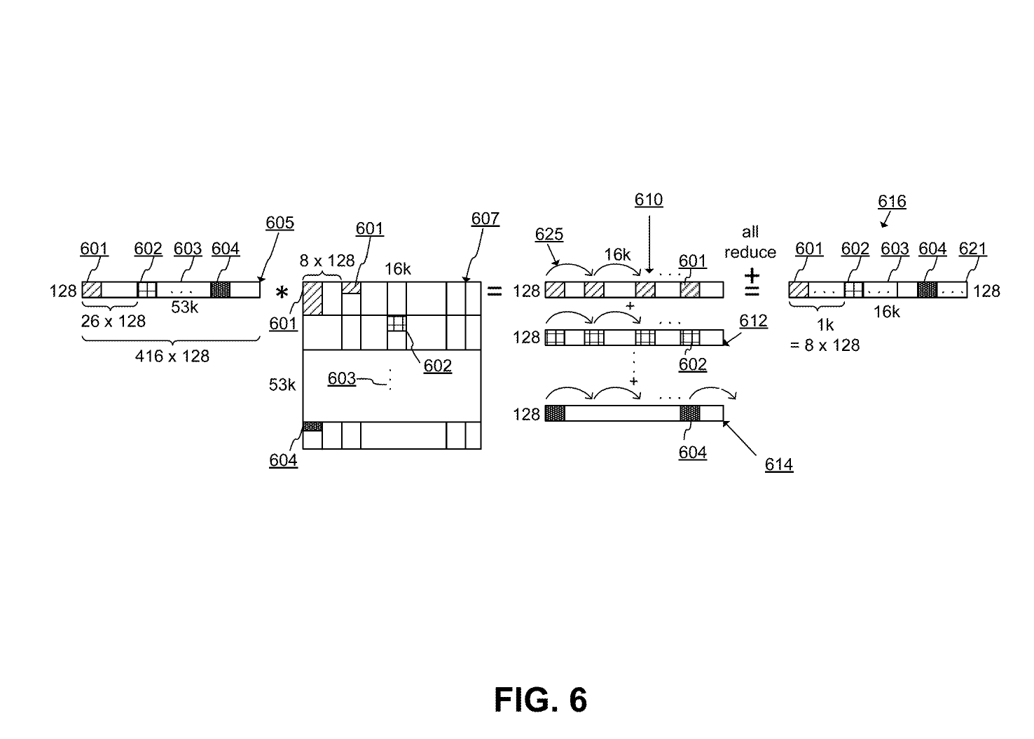

FIG. 6 illustrates a sweep in a second parallelization mode in which tiles may generate partial sums for a shared output space and may propagate those partial sums among neighbor tiles until an owner tile completes accumulation. This mode may be used when multiple tiles contribute to the same output region so that intermediate values are reduced on the fly rather than written out and re‑read later, which may lower memory traffic and stabilize latency while keeping accumulation local to the tiles’ engines. The figure may progress left to right through four sections: a front‑of‑window lane 605, a multiply‑and‑propagation panel 607, a three‑row destination panel with a top destination row 610, a middle destination row 612, and a bottom destination row 614, and a final result row 616 produced after an all‑reduce. Across all sections the same three sub‑block identities may be tracked for clarity: head 601, next‑in‑line 602, and tail 604, with ellipsis 603 representing the set of intervening sub‑blocks between the head and the tail.

The front‑of‑window lane 605 may depict how head 601, next‑in‑line 602, ellipsis 603, and tail 604 are arranged for the current sweep iteration. A vertical 128 beside front‑of‑window lane 605 may indicate that each step stages 128 activation elements in the row dimension for the engine. A horizontal 53k beneath front‑of‑window lane 605 may indicate an inner dimension k on the order of fifty‑three thousand elements, for example k = 53,248, from which sub‑blocks may be selected. A window‑organization tag 26 by 128 under front‑of‑window lane 605 may indicate that the lane may be traversed in twenty‑six increments of 128 elements along k during the sweep. A total‑coverage tag 416 by 128 beneath front‑of‑window lane 605 may indicate that across tiles and steps the sweep may process four hundred sixteen increments of 128 elements. Sub‑block width and count may be chosen to keep the engine fed at line‑rate while bounding local‑memory use; choosing increments that match the engine block and channel intervals may allow data movement to overlap compute without stalls. If k is not an integer multiple of the chosen increment, tail 604 may include padding so that the final step remains aligned.

The multiply‑and‑propagation panel 607 may show a concurrent snapshot across tiles using three stacked rows that preserve the same identities. The top row in the multiply‑and‑propagation panel 607 may show head 601 as the sub‑block being multiplied with a local weight sub‑block on a tile while a partial sum for the corresponding output region accumulates locally. The middle row in the multiply‑and‑propagation panel 607 may show next‑in‑line 602 acting as the current head at a neighbor tile during the same moment, which reflects that the window may be offset among tiles so all tiles work in parallel. The bottom row in the multiply‑and‑propagation panel 607 may show tail 604 later in the sequence, indicating that this sub‑block is moving toward a head position at some tile in a later step. The stacked‑row layout may convey that different sub‑blocks occupy the head role at different tiles at the same time. An annotation 8 by 128 above the multiply‑and‑propagation panel 607 may indicate that each tile may operate on eight contiguous output‑column groups of width 128 columns each during this phase, which may total around 1k columns per tile, and that per‑tile segments combine to span an example 16k‑wide output. As used herein, running partial may refer to a partial sum that is updated at each tile and forwarded to the next tile for the same output region during the sweep. Keeping the accumulation in running partials within per‑tile accumulators until completion may avoid premature write‑backs and re‑reads of intermediates. Although the multiply‑and‑propagation panel 607 may show three tile columns for clarity, the same pattern may extend to any tile count, and the window length may be chosen so that computation and data movement remain in a steady state.

A practical note about appearance in the multiply‑and‑propagation panel 607: multiple instances of head 601 may appear in different rows or positions. These instances may not indicate a change in the underlying size of head 601. Rather, they may mark distinct tiles and time slots within the same step of the sweep. Shading and small variations in drawn width may help the reader distinguish identities and are not necessarily to scale. In other embodiments the panel may depict more explicit per‑tile boundaries or per‑tile accumulator spans, yet the identity mapping for head 601, next‑in‑line 602, and tail 604 may remain the same. As used herein, accumulator span may refer to the output‑region extent (e.g., a 128 by 128 block or an 8 by 128 stripe) for which a tile’s engine retains intermediate sums before forwarding or final commit. Keeping the accumulator span aligned to engine blocks may maintain predictable buffering and overlap with transfers.

The destination panel to the right of the equals sign may record, for the same moment depicted in the multiply‑and‑propagation panel 607, the partial sums written to the shared output space. The top destination row 610 may collect partial sums produced by tiles currently working on head 601. The middle destination row 612 may collect partial sums produced by tiles currently working on next‑in‑line 602 and may include a 1k tag to remind the reader that a tile may contribute to a 1,024‑column span, which the figure may also annotate as 8 by 128. The bottom destination row 614 may collect partial sums produced by tiles currently working on tail 604. A brace labeled 16k may reaffirm that the three rows together may span the example output width. Neighbor‑reduction arrows 625 may arch over segments of the rows to indicate that partial sums may propagate and combine among neighbor tiles so that each output region’s contributions are brought together as the sweep proceeds. As used herein, neighbor reduction may refer to a reduction pattern in which a running partial traverses one hop per step along the ring, accumulating the local contribution at each tile for the same output coordinates. This one‑hop cadence may confine traffic to short links, reduce head‑of‑line blocking, and avoid the duplicate memory traffic of writing out and later re‑reading per‑tile partials. Plus signs drawn between row segments may serve as a visual reminder that these contributions may be added for the same output locations as they move. Other embodiments may use different per‑tile spans or different visual groupings, for example 4 by 128 or 16 by 128, but the notion of per‑tile contribution and neighbor reduction may remain.

The final result row 616 may represent the state after an all‑reduce across the partial sums represented by the three destination rows. As used herein, all‑reduce may refer to a collective operation that combines contributions from multiple tiles into a single final value for each output location and makes the result available to the owning tile for commit. The all‑reduce may be realized as a neighbor‑to‑neighbor reduction that converges on an owner tile or as a collective that yields the same final value without writing intermediate partial sums to a shared memory region. The final result row 616 may depict committed outputs for the regions that have completed accumulation at that moment. Retaining the default address mapping for commits may keep writes deterministic and local to the owner tile’s channel group, which may simplify bandwidth planning and improve latency predictability relative to non‑localized commit paths. The same identity ordering may be preserved so the reader can see head 601, next‑in‑line 602, ellipsis 603, and tail 604, and a continuation marker 621 may indicate that the pattern extends across the remaining output width.

A sweep may proceed as follows. A tile may stage the current head 601 together with a local weight sub‑block, may compute a multiply–accumulate into its partial‑sum region, and may forward the running partial to a neighbor tile. The neighbor tile may add its contribution for the same region and may forward the running partial again. This may continue until an owner tile for that region completes the accumulation and writes the final value that appears in the final result row 616. In parallel the same tile may receive a running partial for another region while sending its own running partial for a different region. This organization may maintain a steady state in which computation overlaps with neighbor passes and partial sums do not proliferate in memory. The owner tile, which may be determined by the address‑to‑tile mapping described above, may complete accumulation for its assigned output region and commits the final value.

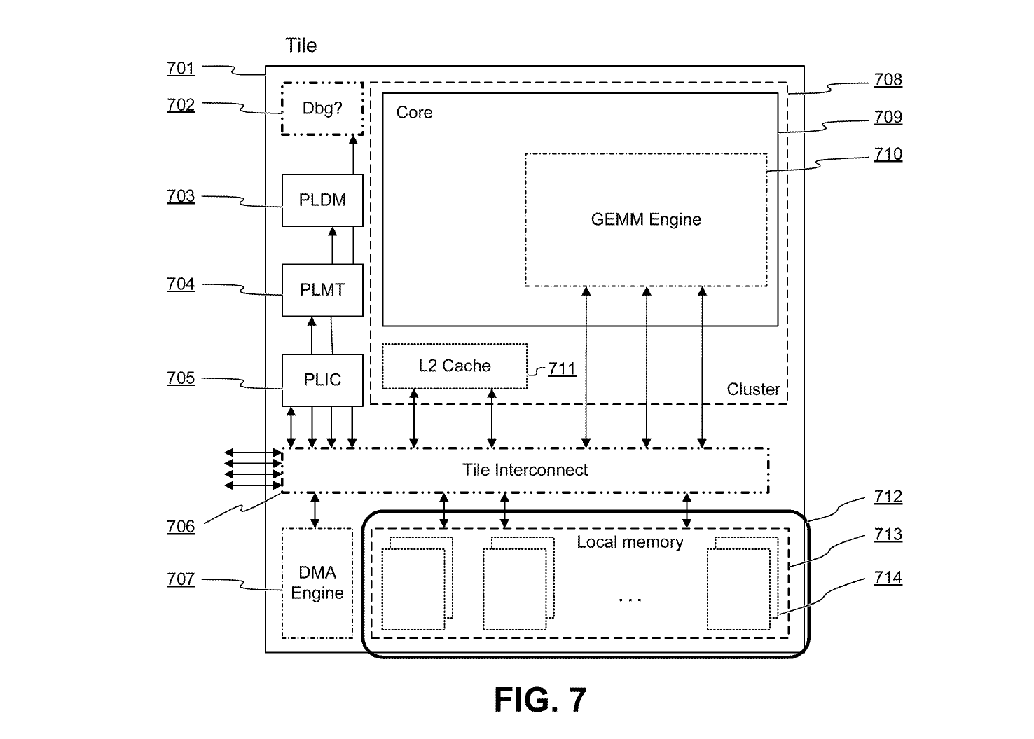

FIG. 7 illustrates a compute tile 701 that stages data in local memory, communicates over a tile interconnect, and executes matrix operations under control of a processor core and service blocks. A dotted cluster boundary 708 may group the main compute resources of compute tile 701, including core 709, a general matrix–matrix multiplication engine (GEMM engine) 710, and an L2 cache 711. The lower portion may show a software‑managed local‑memory subsystem 712 that contains a local memory region 713 divided into banks 714 sized to the engine’s preferred block granularity. A tile interconnect 706 may provide the high‑bandwidth path among these elements and to neighboring tiles or memory‑side components, and a direct‑memory‑access engine (DMA engine) 707 may move blocks between software‑managed local‑memory subsystem 712 and external destinations reachable via tile interconnect 706.

Core 709 may be a control processor that runs firmware to orchestrate tile operation. Core 709 may configure address maps, initiate or retire work on GEMM engine 710, and set up DMA descriptors for DMA engine 707. As used herein, descriptor may refer to a control record that declares at least a source or destination address, a block size, and options such as stride or reduction mode for use by a DMA engine. Core 709 may rely on L2 cache 711 for code and metadata, while workload tensors used by GEMM engine 710 may be staged explicitly in software‑managed local‑memory subsystem 712 so that sizes and alignments match the engine feed. Arrows between core 709, L2 cache 711, tile interconnect 706, and GEMM engine 710 may indicate control and data paths. For example, core 709 may program GEMM engine 710 through memory‑mapped registers. As used herein, memory‑mapped register may refer to a control register that is accessed by reads and writes to a defined address so that software can configure the target block without a separate bus protocol.

GEMM engine 710 may perform block‑oriented tensor computations. In one embodiment the engine may operate on blocks sized to the engine width in both dimensions so that a single bank 714 can supply a block at a time. GEMM engine 710 may retain internal accumulators for a block until accumulation completes, then may signal completion to the control flow so that DMA engine 707 can write out results or forward partial sums. L2 cache 711 may cache control structures and small data used by core 709 while bulk tensor data remains in software‑managed local‑memory subsystem 712 to avoid cache thrash and to provide deterministic bandwidth to GEMM engine 710. The dotted cluster boundary 708 may indicate that core 709, GEMM engine 710, and L2 cache 711 share a low‑latency internal fabric and, in some embodiments, a common clock or power domain to simplify scheduling and coherency within the cluster.

Tile interconnect 706 may be the ingress and egress point for high‑rate data movement. Tile interconnect 706 may deliver input activations to software‑managed local‑memory subsystem 712, may carry outputs toward memory‑side buffers, and may support neighbor‑to‑neighbor exchanges of data such as input windows or running partial sums. DMA engine 707 may attach directly to tile interconnect 706 so that it can source or sink bursts without involving core 709 once descriptors are programmed. DMA engine 707 may also perform local rearrangements within software‑managed local‑memory subsystem 712—for example, transposing a block or packing dequantized values—so that GEMM engine 710 receives data in its preferred layout. The arrows between tile interconnect 706 and local‑memory region 713 may denote these DMA‑driven reads and writes, while arrows between local‑memory region 713 and GEMM engine 710 may denote the steady consumption and production of block‑sized data by the compute engine.

Software‑managed local‑memory subsystem 712 may be the software‑managed scratchpad for the tile. The local memory region 713 may denote the currently provisioned working region inside software‑managed local‑memory subsystem 712 that holds input blocks, weight blocks, in‑progress partial sums, and outputs destined for a next operation. The banks 714 inside local memory region 713 may represent banks or slices, each sized to hold one engine block plus any per‑block metadata such as scales for quantized weights. Banks 714 may be used in ping‑pong or ring fashion so that one bank feeds GEMM engine 710 while another is being filled or drained by DMA engine 707. As used herein, ping‑pong may refer to alternating between two buffers so that one is consumed while the other is filled to maintain overlap between transfer and compute. In other embodiments banks 714 may be interleaved to increase effective bandwidth or assigned to roles such as input, weight, and partial‑sum staging to simplify scheduling.

A service and management side may appear on the left. A platform‑level data model interface 703 (PLDM 703) may provide a management‑plane endpoint used for discovery, configuration, and telemetry. As used herein, management plane may refer to the control path that carries configuration and health information separate from high‑rate data movement. A platform‑management transport 704 (PLMT 704) may be the transport path that carries those management messages. A platform‑level interrupt controller 705 (PLIC 705) may collect interrupt requests from functional blocks and present prioritized notifications to software. In the drawing, PLDM 703 may feed PLMT 704, and PLIC 705 may also connect to PLMT 704 so that management events and interrupts share a control path. PLIC 705 may additionally connect to tile interconnect 706 to expose doorbells or interrupts to a fabric‑visible destination when software runs elsewhere. As used herein, doorbell may refer to a lightweight, write‑based notification that a producer issues to signal readiness or completion without transferring a payload. As used herein, fabric‑visible destination may refer to an addressable endpoint on the interconnect—such as another tile or a management agent—that can receive interrupts or doorbells even when the initiating software is running on a different tile or host. A debug block 702 may be a diagnostics or run‑control agent. The question mark next to Debug may indicate that this block is optional or its exact features are implementation‑specific. In the depicted arrangement, PLDM 703 may connect upward to debug block 702 so that debug capabilities can be surfaced through the same management plane. If desired in other embodiments, debug block 702 may also expose a control channel to core 709 for halting, stepping, or tracing; the figure does not show that path explicitly, which may indicate that such a connection is optional.

Putting these connections together, an example flow may proceed as follows. Software on core 709 may receive a start‑of‑work event via PLIC 705. Core 709 may then program DMA engine 707 with descriptors that read an input window from an external source over tile interconnect 706 and place the blocks into banks 714 of local‑memory region 713. GEMM engine 710 may be armed to consume those banks in its preferred order, producing partial sums back into banks 714. When a block completes, GEMM engine 710 may set a status bit or raise an interrupt to PLIC 705. DMA engine 707 may then write the completed block out over tile interconnect 706 to a designated destination—either a memory‑side buffer or a neighbor tile—while simultaneously fetching the next input or weight block so that compute remains overlapped with movement. PLMT 704 and PLDM 703 may carry configuration and telemetry for this sequence, such as setting the number of banks 714 to allocate for each role, reporting transfer counters, or adjusting throttles if a downstream fabric becomes congested. Debug block 702 may observe or log these phases for bring‑up or diagnostics.

This organization may admit several variations without changing the operative principles. PLDM 703, PLMT 704, and PLIC 705 may be combined into a single service complex or distributed across the dotted cluster boundary 708. L2 cache 711 capacity and policies may be tuned to the firmware footprint, and local‑memory region 713 and banks 714 may be resized or re‑banked to match different engine widths or quantization formats. DMA engine 707 may support advanced features such as multicast to multiple tiles or in‑flight reduction for partial sums. As used herein, multicast may refer to sending a single fetched block to multiple destination tiles without repeated reads. As used herein, in‑flight reduction may refer to combining partial results within the data path as they are forwarded so that fewer bytes are written back to memory. Regardless of these choices, compute tile 701 may retain the same pattern of software‑directed local staging in software‑managed local‑memory subsystem 712, explicit DMA movement over tile interconnect 706, and block‑oriented execution on GEMM engine 710 under coordination from core 709, with interrupts managed by PLIC 705 and configuration and telemetry surfaced through PLDM 703 and PLMT 704 and optionally observed by debug block 702.

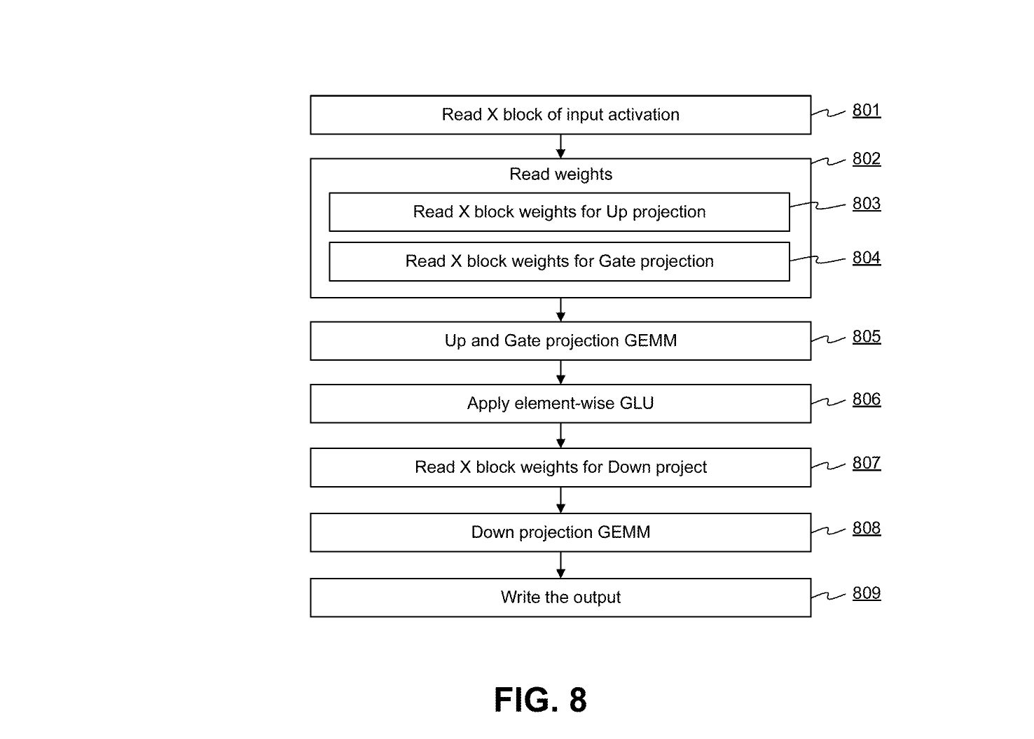

FIG. 8 illustrates a fused execution flow in which tiles may process an activation window and a sequence of projections in a steady state. The sequence may proceed from 801 through 809 and may repeat until all outputs are produced. In this context, an X block may be a block of tensor data sized to the engine’s preferred granularity so that transfers and compute can overlap efficiently; for example, an X block may be 128 by 128 elements in one embodiment, while other sizes such as 64 by 128, 128 by 256, or 256 by 256 may be used in other embodiments to match an engine width, a cache‑line size, a channel stride, or a chosen quantization layout. As used herein, channel stride may refer to the address increment that advances successive transfers across channels so that bandwidth is balanced at the granularity used by the engine and DMA. A projection may refer to a matrix multiplication that maps activations from one feature dimension to another; a GEMM may denote a general matrix–matrix multiplication kernel used to realize a projection; and a GLU may denote a gated linear unit that combines two projected tensors by applying a gate function element‑by‑element. Fusing these operations may reduce intermediate activation growth, avoid unnecessary write‑back and re‑read cycles, and keep engines and channels occupied in a repeating rhythm.

The flow may begin at step 801 by staging one X block of input activations into local memory for the engine. As used herein, staging may refer to copying or DMA‑transferring a contiguous tile of activations into a software‑managed scratchpad so that the engine can read it at a regular cadence. The operation may be organized with ping‑pong buffers, which may be two alternating buffers that allow one buffer to feed the engine while the other is refilled, or ring buffers, which may be a circular set of buffers that are filled and drained in order; both patterns may help maintain a steady state, which may be a condition where data movement and computation remain overlapped across successive blocks.

At step 802 the system may read the parameter blocks required for the two upstream projections while the activation block remains resident. Sub‑step 803 may read an X‑sized block of weights for an up‑projection. As used herein, up‑projection may map each activation vector of length d into a higher‑dimensional vector of length d_ff, where d_ff may be a multiple of d, for example two times or four times larger; the term expanded feature space may refer to this higher‑dimensional target space in which additional coordinates allow later stages to express richer linear combinations. Sub‑step 804 may read an X‑sized block of weights for a gate‑projection. As used herein, gate‑projection may map the same activation into a companion tensor, which may be a tensor that matches the up‑projection output in shape so that the two can be combined element‑by‑element in a later gating operation. Weight blocks read in steps 803 and 804 may be stored in column‑major layout, which may mean that consecutive memory addresses traverse down a logical column so that the engine can stream a column in fixed‑size segments, and may be aligned to a channel interval, which may mean that columns or column segments begin at addresses that naturally stripe across the tile’s memory channels at a fixed interval (for example, every 64 kilobytes) to keep all channels busy while staying within a tile‑private address range. The weights may be represented with quantized groups, which may mean that a set of consecutive weight elements—such as groups of 32 elements—share a scale value stored contiguously with the group; a scale may be a multiplicative factor used to map between a compact integer representation and a higher‑precision internal format; some formats may also include a zero point, which may be an additive offset used with the scale to reconstruct the original range. While the activations remain staged, this portion of the flow may employ column‑parallel sweeps, which may mean that model parameters are sharded across tiles while the same X activation block is made available to each tile so each tile may compute a disjoint slice of the projected outputs using its local shard and the shared input. As used herein, column‑parallel sweeps may refer to a schedule in which the parameter matrix is partitioned by output columns among tiles and the same input block is circulated or broadcast so that each tile produces a non‑overlapping slice of the output.

With activations and both weight blocks staged, step 805 may perform the up‑ and gate‑projection GEMMs. A GEMM in this setting may compute O = A·W, where A may be the X block of activations and W may be a block of weights, producing a block‑sized tile O; the engine may retain internal accumulators for the tile until accumulation finishes for that tile, which may avoid premature write‑back of partial results and may simplify overlap with the next transfers. The up‑projection at step 805 may produce the expanded feature block of size d_ff per activation row, and the gate‑projection may produce the gate block of the same shape so that both tensors are aligned for the next element‑wise stage. Buffering may be arranged so that as one projection block completes, the other block is already staged; this may keep arithmetic pipelines occupied and memory channels evenly utilized.

At step 806 the flow may apply the element‑wise GLU to the two projected tensors while they are still resident in local memory. Element‑wise may mean that the operation is applied coordinate‑by‑coordinate to pairs of values at matching indices. The gating function may be a simple nonlinearity applied to the gate tensor and multiplied by the up tensor. A nonlinearity may be any function that is not a straight line; common choices may include the sigmoid, tanh, and SiLU. A sigmoid may be the logistic function σ(x) = 1/(1+e^(−x)), which may map real numbers to the open interval (0, 1) and therefore may act like a soft gate; tanh may be the hyperbolic tangent that maps to (−1, 1), and SiLU (sometimes called swish) may be x·σ(x), which may smoothly gate values while preserving sign. Performing GLU in‑place may mean writing the combined result back into one of the two source buffers (for example, overwriting the up‑projection buffer with the gated values) so that no additional buffer is required; this may reduce memory traffic and may keep the transient footprint within a per‑tile budget. As used herein, in‑place may refer to computing a result by overwriting one of the inputs so that no further buffer is allocated for the intermediate.

The sequence may then move to step 807, which may stage the parameter block for a down‑projection. A down‑projection may map the gated, expanded feature vectors back to the original feature dimension d (or to another target dimension) so that the layer’s output has the desired width. At this point the schedule may switch to row‑parallel sweeps, which may mean that each tile computes partial sums for a shared output address space rather than a private slice. As used herein, row‑parallel sweeps may refer to a schedule in which tiles hold disjoint row partitions of the weight matrix for a common output region and cooperatively accumulate contributions for the same output coordinates. A partial sum may be a running accumulation for a block of the output that is not yet complete, and tiles may pass the running partial among neighbors so that contributions are aggregated. As used herein, neighbor‑to‑neighbor propagation may refer to short‑hop transfers between adjacent tiles on the interconnect so that reductions advance with bounded link distance. An owner tile may be the tile that is responsible for completing accumulation and committing the final value for a given output region, and the owner may be derived from an address‑to‑tile mapping, which may be a rule that maps output addresses to responsible tiles.

Using the GLU result as input, step 808 may execute the down‑projection GEMM while the neighbor‑to‑neighbor accumulation proceeds. Each tile may compute its local contribution for the current output block, may add any contribution it has received for the same block from a neighbor, and may forward the updated running partial to the next neighbor. This may continue until the owner tile for that block receives the final running partial and the accumulation is complete. Because the running partial may remain local to tiles and their accumulators until completion, the system may avoid writing incomplete values to external memory and later reading them back for a second‑stage reduction, which may lower bandwidth demand and may stabilize latency. As used herein, running partial may refer to a partial sum that is updated at each tile and forwarded to the next tile for the same output region during the sweep.

Finally, step 809 may commit the completed output block to memory once the owner tile has finished accumulation for the block associated with the current X input. Commit may mean performing a single write of the final values to the designated output address range with any required ordering or visibility semantics. As used herein, ordering or visibility semantics may refer to the guarantees required so that subsequent consumers observe committed data in program order and with the intended coherence properties. After commitment the window may advance to the next X block of activations and steps 801 through 809 may repeat until all outputs are produced. In steady state the pipeline may keep each stage busy—for example, while the current projections complete for one X block, the next activation block may be fetched; while GLU is applied, the down‑projection weights for that block may be arriving; while the down‑projection reduction proceeds, the previous block’s outputs may be committing—so that the engine and the interconnect may remain well utilized. Parameters such as X‑block size, column‑major versus row‑major weight layout, channel‑interval alignment distance, quantization group size and metadata placement, and sweep lengths for column‑parallel and row‑parallel phases may be tuned to match engine width, channel counts, and memory alignment, while preserving the fused, limited‑footprint, repeat‑until‑done behavior of the flow.

As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C.

A number of implementations have been described. Nevertheless, it will be understood that various modifications may be made without departing from the spirit and scope of the disclosure. Accordingly, other implementations are within the scope of the following claims.

It is understood that the described systems or apparatuses are not mutually exclusive, and elements, components, materials, or steps described in connection with one example method, system, or apparatus may be combined with, or eliminated from, other disclosed methods, systems, or apparatuses in suitable ways to accomplish desired design objectives.

In the foregoing specification, the disclosed systems or apparatuses have been described with reference to numerous specific details that can vary from implementation to implementation. Certain adaptations and modifications of the described systems or apparatuses can be made. Various renditions of the disclosed systems or apparatuses can be apparent to those skilled in the art from consideration of the specification and practice of the invention disclosed herein. It is intended that the specification and examples be considered as exemplary only.

The present technology includes devices, apparatuses, and assemblies addressed in the aspects of the present technology presented below:

Aspect I: A computing system comprising:
a processing system including one or more processors;
compute tiles;
a memory subsystem; and
an interconnect arranged to communicate the compute tiles;
the one or more processors configured to:
   operate the compute tiles to perform tensor computations using per-tile compute engines that accumulate partial results;
   set a memory addressing scheme using a system address decoder that provides tile-private address ranges for data used by a given tile and tile-shared address ranges for data used by multiple tiles;
   execute a first parallelization mode in which a parameterized portion of a model dataset is distributed among at least a portion of the compute tiles and input data is made available across the compute tiles;
   execute a second parallelization mode in which the compute tiles produce partial results for a common output address space and propagate the partial results among neighbor tiles to an owner tile that completes accumulation and commits the output; and
   perform a fused execution to maintain a steady state.

Aspect II: The computing system of Aspect I, wherein the fused execution is performed across projecting and gating operations and comprises avoiding growth of intermediate activation tensors while overlapping data movement and computation within a per-tile memory budget; and wherein the memory addressing scheme defines tile-private address ranges and tile-shared address ranges.

Aspect III: The computing system of any of Aspects I–II, wherein the memory addressing scheme is configurable at system boot to adjust granularity of tile-level access and granularity of channel-level access.

Aspect IV: The computing system of any of Aspects I–III, wherein the memory addressing scheme is implemented by the system address decoder of the memory subsystem that assigns channel identifiers and tile identifiers to predetermined bit positions to realize channel intervals and tile intervals.

Aspect V: The computing system of any of Aspects I–IV, wherein the channel identifiers occupy bits 17–16 and the tile identifiers occupy bits 28–25 to provide a channel interval of about 64 KB and a tile interval of about 64 MB.

Aspect VI: The computing system of any of Aspects I–IV, wherein, for input or output data, the bit positions of the channel identifiers and the tile identifiers are reversed to shape traffic.

Aspect VII: The computing system of any of Aspects I–VI, wherein parameter weights of the model dataset are stored within a tile-private address range of the memory subsystem in a quantized format in which groups of consecutive elements share a scale value.

Aspect VIII: The computing system of any of Aspects I–VII, wherein each group includes at least 32 elements that share a single scale.

Aspect IX: The computing system of any of Aspects I–VIII, wherein the parameter weights of the model dataset are stored contiguously.

Aspect X: The computing system of any of Aspects I–IX, wherein the first parallelization mode proceeds in steps, rounds, and sweeps.

Aspect XI: The computing system of any of Aspects I–X, wherein in the first parallelization mode, an input-data block is passed via the interconnect from a first compute tile to a neighbor compute tile after the first compute tile performs a matrix multiplication on the block using its per-tile compute engine.

Aspect XII: The computing system of any of Aspects I–XI, wherein in the first parallelization mode a windowing mechanism selects non-contiguous input-data blocks using a stride set as a function of an inner matrix dimension, a tile count, and an engine block width of a per-tile compute engine.

Aspect XIII: The computing system of any of Aspects I–XII, wherein the stride is k/(T×B), where k is the inner dimension, T is the tile count, and B is the per-tile block width.

Aspect XIV: The computing system of any of Aspects I–XIII, wherein the first parallelization mode schedules transfers and computations to reduce redundant movement of parameter data and output data for an output region of the common output address space and to bound re-access of input data while advancing work across tiles.

Aspect XV: The computing system of any of Aspects I–XIV, wherein the fused execution performs an up-projection and a gate-projection in the first parallelization mode, applies a gating operation in place, and performs a down-projection in the second parallelization mode with neighbor-to-neighbor reduction to an owner tile to complete accumulation and commit the output.

Aspect XVI: A method comprising:
operating compute tiles to perform tensor computations using per-tile compute engines that internally accumulate partial results to completion;
managing a memory addressing scheme using a system address decoder that provides tile-private address ranges for data used by a given tile and tile-shared address ranges for data used by multiple tiles;
executing a first parallelization mode in which a parameterized portion of a model dataset is distributed among tiles and input data is made available across tiles, the mode advancing work across tiles;
executing a second parallelization mode in which tiles produce partial results for a common output address space and propagate the partial results among neighbor tiles to an owner tile that completes accumulation and commits the output; and
performing a fused execution across projection and gating operations to maintain a steady state and avoid growth of intermediate activation tensors while overlapping data movement and computation within a per-tile memory budget.

Aspect XVII: The method of Aspect XVI, wherein the memory addressing scheme defines tile-private address ranges and tile-shared address ranges.

Aspect XVIII: The method of any of Aspects XVI–XVII, wherein the memory addressing scheme is configurable at system boot to adjust granularity of tile-level access and granularity of channel-level access.

Aspect XIX: The method of any of Aspects XVI–XVIII, wherein the system address decoder assigns channel identifiers and tile identifiers to predetermined bit positions to realize channel intervals and tile intervals.

Aspect XX: The method of any of Aspects XVI–XIX, wherein the channel identifiers occupy bits 17–16 and the tile identifiers occupy bits 28–25 to provide a channel interval of about 64 KB and a tile interval of about 64 MB.

Aspect XXI: The method of any of Aspects XVI–XIX, wherein, for input or output data, the bit positions of the channel identifiers and the tile identifiers are reversed to shape traffic.

Aspect XXII: The method of any of Aspects XVI–XXI, wherein parameter weights of the model dataset are stored in a quantized format in which groups of consecutive elements share a scale value.

Aspect XXIII: The method of any of Aspects XVI–XXII, wherein each group includes 32 elements that share a single scale.

Aspect XXIV: The method of any of Aspects XVI–XXII, wherein parameter weights of the model dataset are stored column-major with scales stored contiguously to corresponding groups, and each weight column is padded to a channel-aligned interval and distributed across channels within a tile to sustain multi-channel feeding of the per-tile compute engines.

Aspect XXV: The method of any of Aspects XVI–XXIV, wherein the first parallelization mode proceeds in steps, rounds, and sweeps.

Aspect XXVI: The method of any of Aspects XVI–XXV, wherein an input-data block is passed to a neighbor tile after a tile performs a matrix multiplication on that block.

Aspect XXVII: The method of any of Aspects XVI–XXVI, wherein a windowing mechanism selects non-contiguous input-data blocks using a stride set as a function of an inner matrix dimension, a tile count, and an engine block width.

Aspect XXVIII: The method of any of Aspects XVI–XXVII, wherein the stride is k/(T×B), where k is the inner dimension, T is the tile count, and B is the per-tile block width.

Aspect XXIX: The method of any of Aspects XVI–XXVIII, wherein the first parallelization mode schedules transfers and computations to reduce redundant movement of parameter data and output data for an output region of the common output address space and to bound re-access of input data while advancing work across tiles.

Aspect XXX: The method of any of Aspects XVI–XXIX, wherein the fused execution performs an up-projection and a gate-projection in the first parallelization mode, applies a gating operation in place, and performs a down-projection in the second parallelization mode with neighbor-to-neighbor reduction to an owner tile to complete accumulation and commit the output.

Aspect XXXI: An apparatus comprising:
a processing system including one or more processors;
a plurality of compute tiles;
a memory subsystem; and
an interconnect arranged to communicate among the compute tiles;
the processors configured to:
   operate the compute tiles to perform tensor computations using per-tile compute engines that internally accumulate partial results to completion;
   manage a memory addressing scheme using a system address decoder that provides tile-private address ranges for data used by a given tile and tile-shared address ranges for data used by multiple tiles;
   execute a first parallelization mode in which a parameterized portion of a model dataset is distributed among tiles and input data is made available across tiles, the mode advancing work across tiles;
   execute a second parallelization mode in which tiles produce partial results for a common output address space and propagate the partial results among neighbor tiles to an owner tile that completes accumulation and commits the output; and
   perform a fused execution across projection and gating operations to maintain a steady state and avoid growth of intermediate activation tensors while overlapping data movement and computation within a per-tile memory budget.

Aspect XXXII: The computing system of any of Aspects I–XV, wherein the one or more processors are further configured to execute a steady-state pipeline in which movement of data via the interconnect among the memory subsystem and the compute tiles overlaps with the tensor computations across successive iterations.

Aspect XXXIII: The computing system of any of Aspects I–XV, wherein the interconnect comprises at least one of: at least one ring interconnect that connects the compute tiles in a cyclic ordering; and a plurality of ring interconnects and data is interleaved across the plurality of ring interconnects.

Aspect XXXIV: The computing system of any of Aspects I–XV, wherein the compute tiles are partitioned into a plurality of domains, and wherein each domain is associated with a respective subset of memory channels of the memory subsystem; and wherein the parameterized portion of the model dataset is distributed across the plurality of domains such that each domain stores a respective subset of model parameters in the memory subsystem.

Aspect XXXV: The computing system of any of Aspects I–XV, wherein the memory subsystem comprises pseudo-channels, and wherein each compute tile is associated with a respective subset of the pseudo-channels.

Aspect XXXVI: The computing system of any of Aspects I–XV, wherein the memory addressing scheme defines a first memory address range using a coarse-grain interleaving across memory channels of the memory subsystem and a second memory address range using a fine-grain interleaving across memory channels of the memory subsystem.

Aspect XXXVII: The computing system of any of Aspects I–XV, further comprising a direct memory access (DMA) engine configured to transfer data between the memory subsystem and local memory of a compute tile or local memory of a first compute tile and local memory of a second compute tile.

Aspect XXXVIII: The computing system of any of Aspects I–XV, wherein the per-tile compute engines retain accumulator contents for a tensor computation until completion of accumulation for a common output address space and commit the output to the memory subsystem.

Aspect XXXIX: The computing system of any of Aspects I–XV, wherein the model dataset comprises quantized weights, and wherein the memory subsystem stores quantized weight values and scale values shared across a group of weight values.

Aspect XL: The computing system of any of Aspects I–XV, wherein the owner tile is determined based on at least one of: an address-to-tile mapping derived from the memory addressing scheme; and a mapping of output regions to compute tiles.

What is claimed is:

1. A computing system, comprising:
a processing system including one or more processors;
compute tiles;
a memory subsystem;
and an interconnect arranged to communicate the compute tiles;
wherein the one or more processors are configured to:
operate the compute tiles to perform tensor computations using per‑tile compute engines that accumulate partial results;
set a memory addressing scheme using a system address decoder that provides tile-private address ranges for data used by a given tile and tile-shared address ranges for data used by multiple tiles;
execute a first parallelization mode in which a parameterized portion of a model dataset is distributed among at least a portion of the compute tiles and input data is made available across the compute tiles;
execute a second parallelization mode in which the compute tiles produce partial results for a common output address space and propagate the partial results among neighbor tiles to an owner tile that completes accumulation and commits the output; and
perform a fused execution to maintain a steady state.

2. The system of claim 1, wherein
the fused execution is performed across projecting and gating operations and comprises avoiding growth of intermediate activation tensors while overlapping data movement and computation within a per‑tile memory budget; and
the memory addressing scheme defines tile‑private address ranges and tile‑shared address ranges.

3. The system of claim 2, wherein the memory addressing scheme is configurable at system boot to adjust granularity of tile‑level access and granularity of channel‑level access.

4. The system of claim 1, wherein the memory addressing scheme is implemented by the system address decoder of the memory subsystem that assigns channel identifiers and tile identifiers to predetermined bit positions to realize channel intervals and tile intervals.

5. The system of claim 4, wherein the channel identifiers occupy bits 17–16 and the tile identifiers occupy bits 28–25 to provide a channel interval of about 64 KB and a tile interval of about 64 MB.

6. The system of claim 4, wherein, for input or output data, the bit positions of the channel identifiers and the tile identifiers are reversed to shape traffic.

7. The system of claim 1, wherein parameter weights of the model dataset are stored within a tile-private address range of the memory subsystem in a quantized format in which groups of consecutive elements share a scale value.

8. The system of claim 7, wherein each group includes at least 32 elements that share a single scale.

9. The system of claim 7, wherein the parameter weights of the model dataset are stored contiguously.

10. The system of claim 1, wherein the first parallelization mode proceeds in steps, rounds, and sweeps.

11. The system of claim 10, wherein in the first parallelization mode, an input‑data block is passed via the interconnect from a first compute tile to a neighbor compute tile after the first compute tile performs a matrix multiplication on the block using its per-tile compute engine.

12. The system of claim 1, wherein in the first parallelization mode a windowing mechanism selects non‑contiguous input‑data blocks using a stride set as a function of an inner matrix dimension, a tile count, and an engine block width of a per-tile compute engine.

13. The system of claim 12, wherein the stride is k/(T×B), where k is the inner dimension, T is the tile count, and B is the per‑tile block width.

14. The system of claim 1, wherein the first parallelization mode schedules transfers and computations to reduce redundant movement of parameter data and output data for an output region of the common output address space.

15. The system of claim 1, wherein the fused execution performs an up‑projection and a gate‑projection in the first parallelization mode, applies a gating operation in place, and performs a down‑projection in the second parallelization mode with neighbor‑to‑neighbor reduction to an owner tile to complete accumulation and commit the output.

16. A method comprising:
operating compute tiles to perform tensor computations using per‑tile compute engines that internally accumulate partial results to completion;
managing a memory addressing scheme using a system address decoder that provides tile‑private address ranges for data used by a given tile and tile‑shared address ranges for data used by multiple tiles;
executing a first parallelization mode in which a parameterized portion of a model dataset is distributed among tiles and input data is made available across tiles, the mode advancing work across tiles;
executing a second parallelization mode in which tiles produce partial results for a common output address space and propagate the partial results among neighbor tiles to an owner tile that completes accumulation and commits the output; and
performing a fused execution across projection and gating operations to maintain a steady state and avoid growth of intermediate activation tensors while overlapping data movement and computation within a per‑tile memory budget.

17. The method of claim 16, wherein the memory addressing scheme defines a tile‑private address ranges and tile‑shared address ranges.

18. The method of claim 17, wherein the memory addressing scheme is configurable at system boot to adjust granularity of tile‑level access and granularity of channel‑level access.

19. The method of claim 16, wherein the system address decoder assigns channel identifiers and tile identifiers to predetermined bit positions to realize channel intervals and tile intervals.

20. An apparatus comprising:
a processing system including one or more processors;
a plurality of compute tiles;
a memory subsystem; and
an interconnect arranged to communicate among the compute tiles;
the processors configured to:
operate the compute tiles to perform tensor computations using per‑tile compute engines that internally accumulate partial results to completion;
manage a memory addressing scheme using a system address decoder that provides tile‑private address ranges for data used by a given tile and tile‑shared address ranges for data used by multiple tiles;
execute a first parallelization mode in which a parameterized portion of a model dataset is distributed among tiles and input data is made available across tiles, the mode advancing work across tiles;
execute a second parallelization mode in which tiles produce partial results for a common output address space and propagate the partial results among neighbor tiles to an owner tile that completes accumulation and commits the output; and
perform a fused execution across projection and gating operations to maintain a steady state and avoid growth of intermediate activation tensors while overlapping data movement and computation within a per‑tile memory budget.
